(19) United States
(12) Patent Application Publication
(10) Pub. No.: US 2013/0062377 A1
(43) Pub. Date: Mar. 14, 2013

(54) Interchangable Scooter and Article Carrier System

(71) Applicants: Michael Hughesdon Turner, Arlington, VA (US); Ryan Patrick Murphy, Hermosa Beach, CA (US)

(72) Inventors: Michael Hughesdon Turner, Arlington, VA (US); Ryan Patrick Murphy, Hermosa Beach, CA (US)

(21) Appl. No.: 13/562,266

(22) Filed: Jul. 30, 2012

Related U.S. Application Data
(60) Provisional application No. 61/457,992, filed on Jul. 29, 2011.

(51) Int. Cl. B60R 9/06

(52) U.S. Cl. CPC B60R 9/06
USPC 224/276

(57) ABSTRACT

The Interchangable Scooter and Article Carrier System is a customizable system wherein a kick scooter can be releasably attached to an article carrier, forming a single reconfigurable device that can be used as either a kick scooter or an article carrier. The user can ride the device as a scooter with simultaneous support of the article carrier, or the user can carry the device as an article carrier with simultaneous storage of the scooter. The system utilizes a releasable connection between a rigid frame, attached to a walled container, and a scooter bracket, attached to a portion of the scooter. The scooter bracket is of a multi-part construction so as to be installed on pre-existing commercially available scooters. A deflective interaction between the rigid frame and clamps of the scooter steering assembly creates a selective lock which can maintain the steering position of a front wheel or wheels.

### CROSS REFERENCE TO RELATED APPLICATIONS

This application claims benefit under 35 U.S.C. §119 of provisional patent application No. 61/457,992 filed on Jul. 29, 2011 and entitled “Interchangeable Scooter and Article Carrier System,” the entire contents of which are hereby incorporated by reference.

### BACKGROUND OF THE INVENTION

The purpose of the invention is to provide a system of interchangable scooter and article carrier combinations to create combination scooter and backpack devices (“Scooter Backpacks”). Scooter Backpacks are devices that can be ridden as a scooter or carried as an article carrier. In the present invention, the article carrier and scooter are releasably attached to one another, and may be switched-out, or interchanged, with other article carriers or scooters. Thus, a user may customize their Scooter Backpack with a particular scooter and a particular article carrier, depending on their needs. For example, a longer journey may call for a larger-wheeled scooter; or if sizeable loads are to be carried, a more voluminous article carrier is needed. In this inventive system, the user can pick-and-choose which scooter to use with which carrier through the use of compatible mating components. See FIGS. 1-5 for various views of Scooter Backpacks.

Previous kick scooter and luggage combination devices have not afforded users this ability to customize the scooter and luggage portions of the combination device. They largely consist of kick scooter components, such as a footboard or steering handle, permanently attached to a carrier, creating a device that can be carried or ridden. Thus, in many of these devices, the steering handle and footboard are connected only through the article carrier. This places a large amount of stress on the carrier when riding the combination and will diminish, or entirely altogether eliminate, a user's ability to control the scooter when the carrier comprises flexible walls. Additionally, previous devices do not teach the ability of the article carrier or the scooter, to function independently of the other. This is disadvantageous where a user's circumstances do not require one or the other of the article carrier or scooter.

The present invention solves the above-identified problems with current scooter and article carrier combination devices. The invention also takes advantage of the common structures among commercially available kick scooters, to allow for adaptability to those pre-existing, or used, scooters. Further, the invention provides for a variety of article carriers, each with a particular usefulness, to be combined with various scooters. For example, a longer journey may call for a larger-wheeled scooter; or if sizeable loads are to be carried, a large article carrier. Hence, the invention allows a user to adapt their combination scooter and article carrier to the particular needs of that moment, and to use the scooter they already own.

### SUMMARY OF THE INVENTION

The purpose of the invention is to provide an interchangable scooter and article carrier system for creating combination scooter and backpack devices (“Scooter Backpacks”). A Scooter Backpack can be ridden as a conventional scooter, and then reconfigured to be carried as a conventional article carrier. When in the scooter configuration, a footboard extends away from the device to allow a rider to stand thereon. When in the article carrier configuration, the footboard folds up against a surface of the article carrier for compact transportation. With this system, a user may switch out, or interchange, various article carriers with various scooters, thereby customizing their Scooter Backpack to suit specific needs.

The article carrier is generally comprised of a flexible walled container and a rigid frame. The rigid frame may be completely internal to the container, completely external, or with portions extending through the walls of the container. The rigid frame is adapted to connect to a scooter bracket that has been attached to a portion of the scooter. The bracket is designed to releasably connect with the rigid frame, and to releasably or permanently attach to the scooter. A further portion of the frame is designed to releasably connect with an upper steering portion of the scooter.

The overall size and shape of the rigid frame can be adjusted to suit the design of the walled container, creating a functional article carrier. Generally, the rigid frame connects to the scooter bracket at a lower position on the frame, near the bottom of the article carrier. If the rigid frame is external to the article carrier, the lower portion of the frame visibly connects to the scooter bracket. If the rigid frame is completely, or partially, internal to the article carrier, the scooter bracket must pass through an opening in a wall of the container before engaging with the lower portion of the frame. This opening may be selectively closable, or permanently open. In doing so, it is generally concealed from view.

The upper portion of the rigid frame connects directly to a portion of the scooter steering assembly, rather than through the bracket. This upper portion may be internal to the article carrier, or external. Generally, it may be shaped to deformably connect to a portion of the scooter steering assembly. This connection is designed to be releasable and to not impede a degree of relative rotation between the rigid frame and the steering assembly. This connection is further positioned below any operating point of the handlebars, so as to not block a user's access to them. Thus, the handlebars are generally external to the article carrier.

A further purpose of the invention is to provide for adaptability to existing commercially available kick scooters, in order to transform them into functional scooter backpacks. A great number of conventional kick scooters share structural similarities. The scooter bracket, which connects the article carrier to the frame, is designed to install around those common structures. The scooter bracket is generally comprised of nearly identical halves which surround a portion of the scooter and then fasten to one another. The resulting connection and position of the bracket fixes the scooter bracket to the scooter, providing for a further secure connection to the article carrier.

A further purpose of the invention is to provide for a front wheel lock for a two wheeled scooter. Generally, two wheeled kick scooters are comprised of a steering assembly that is secured the scooter through a steering tube clamp. The steering tube clamp is generally asymmetric, with an extended portion which houses the fasteners for the clamp. The steering tube clamp generally rotates with the steering assembly during steering.

Preferably, the rigid frame and scooter bracket are comprised of a hard plastic, such as acrylonitrile butadiene styrene (“ABS”). Further preferably, the rigid frame is comprised of a front vertical wall. The front vertical wall is located proximate to the steering tube clamp. The front frame wall is positioned so as to not contact the steering tube clamp when the steering assembly is rotated to various positions, but to contact the extended portion of the steering tube clamp in other rotated positions. When the extended portion contacts the front frame wall during rotation, it is designed to deflect the front frame wall an amount necessary to pass by and continue rotation. This rotation continues until a congruent face of the extended portion settles against the congruent surface of the front frame wall, at which point the front vertical wall ceases deflection and creates a stable engagement with the extended portion of the steering tube clamp. When in this stable position, the front wheel of the scooter is locked to a particular angle, until further force is applied to re-deflect the front vertical wall and release the steering tube clamp.

### BRIEF DESCRIPTION OF THE DRAWINGS

FIGS. 1-5 show various views of Scooter Backpacks.

FIG. 6 shows a frame in isolation.

FIGS. 7 and 8 show a frame and a scooter.

FIG. 9 shows a top view of a frame upper portion.

FIG. 10 shows a frame and a scooter.

FIGS. 11a-11c show the connection between frame and scooter.

FIGS. 12a and 12b show an alternate connection between frame and scooter.

FIG. 13 shows a top view of a frame upper portion.

FIGS. 14a and 14b show the connection between frame and scooter.

FIGS. 15a-15c show a partially internal frame, article carrier, and scooter.

FIGS. 16a-16d show a completely external frame, article carrier, and scooter.

FIGS. 17a-17f show various embodiments of the frame.

FIGS. 18a and 18b show a frame and a scooter.

FIG. 19 intentionally ommitted

FIGS. 20a-20d show various embodiments of openings in the frame upper portion.

FIGS. 21a-21d show a frame and a scooter bracket.

FIGS. 22a-22d show various embodiments of openings in the frame upper portion.

FIGS. 23a and 23b show article carriers and frame upper portions.

FIG. 24 shows various embodiments of frame lower portions.

FIG. 25 shows a frame.

FIGS. 26a-26d show an embodiment of the frame and scooter bracket.

FIGS. 27a-27f show an embodiment of the frame and scooter bracket.

FIGS. 28a-28d show an embodiment of the frame and scooter bracket.

FIGS. 29a-29d show an embodiment of the frame and scooter bracket.

FIGS. 30a-30d show an embodiment of the scooter bracket.

FIGS. 31a-31j show further embodiments of the scooter bracket.

FIGS. 32a and 32b show an embodiment of the scooter and scooter bracket.

FIGS. 33a-33d show an embodiment of the scooter bracket.

FIGS. 34a-34f show an embodiment of the scooter, frame, article carrier and scooter bracket.

FIGS. 35a-35f show an embodiment of the article carrier.

FIGS. 36a and 36b show an embodiment of the article carrier.

FIGS. 37a-37c show an embodiment of the article carrier.

FIGS. 38a-38d show and embodiment of the wheel lock.

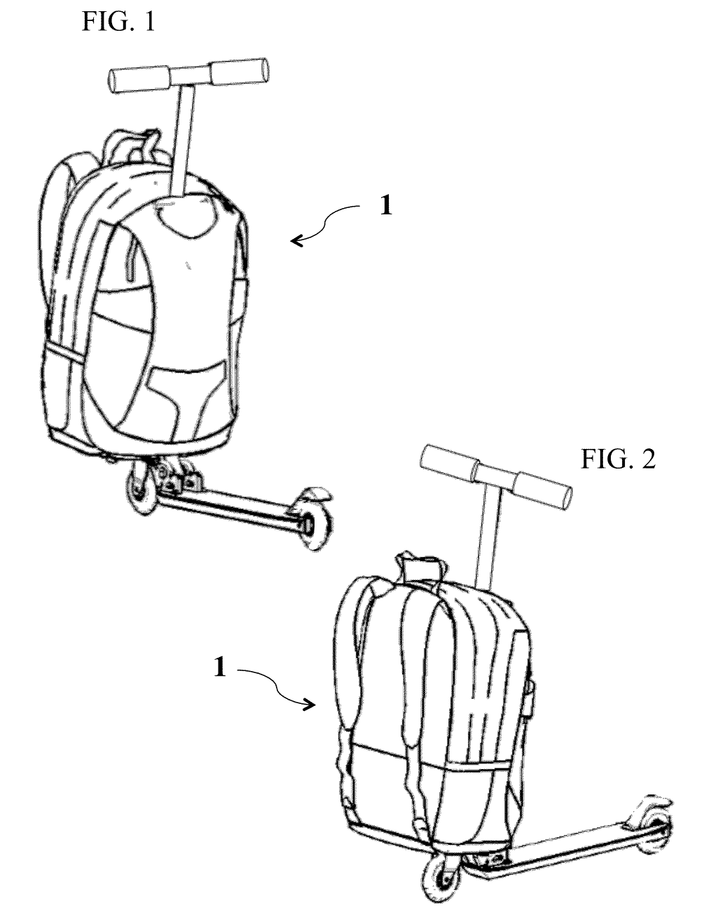

### DETAILED DESCRIPTION

The present invention is a system of interchangable article carrier and kick scooter components that combine to create a single device with the functionality of each component. The invention further provides the components to be releasably separated, allowing each to function as a traditional article carrier or a kick scooter in a standalone fashion. The combination is achieved through a releasable connection between a rigid frame, a component of the article carrier, and a scooter bracket, connected to the kick scooter.

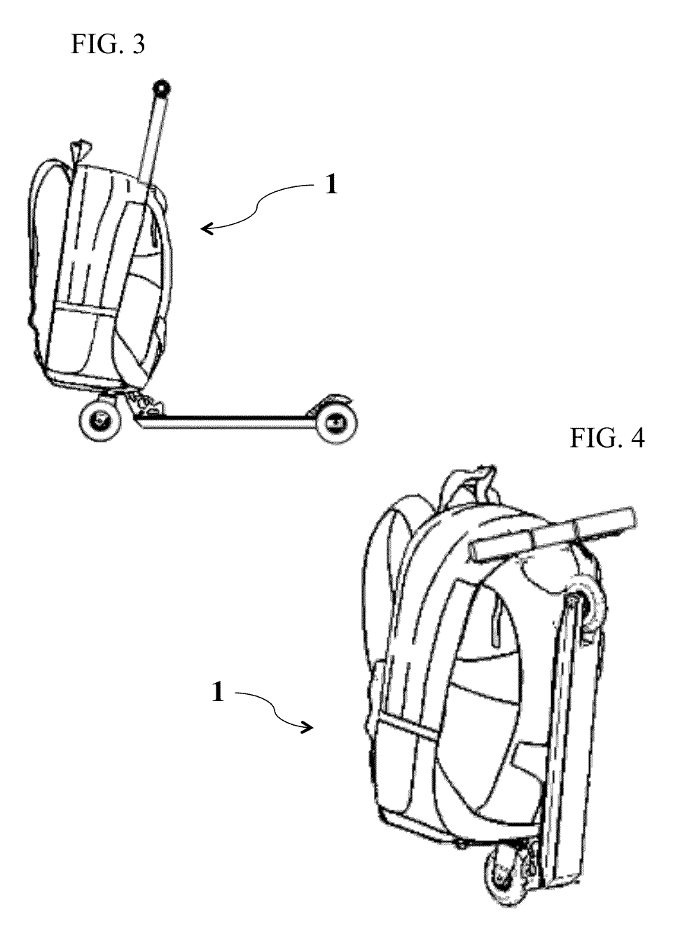

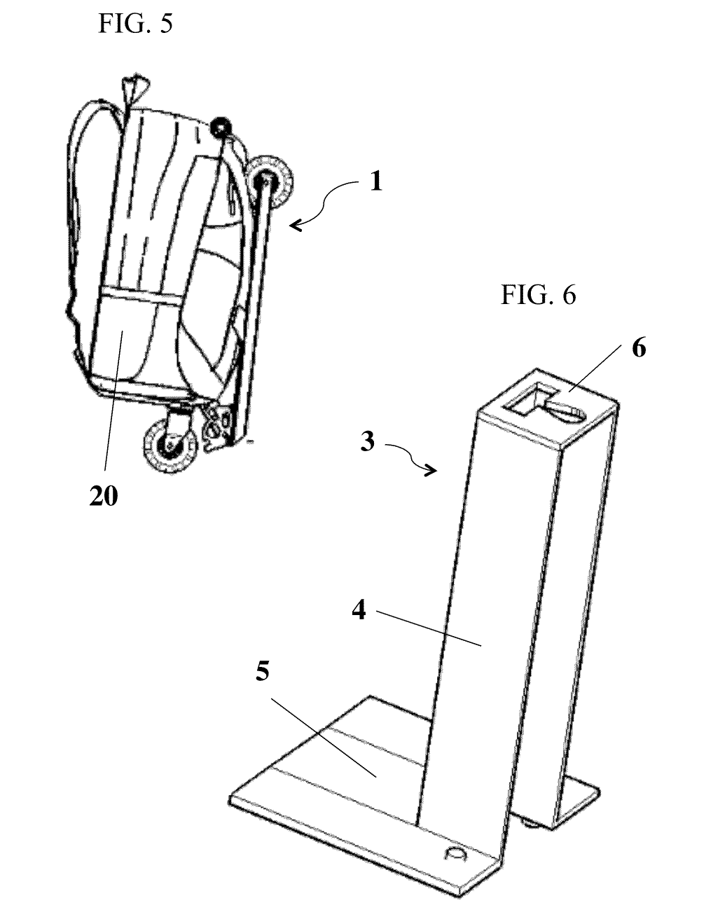

The article carrier is preferably comprised of a flexible walled container 20 attached to a rigid frame 3. This attachment may be permanent, semi-permanent, or releasable; and may be effected at various points along the surface of the flexible walled container 20. The rigid frame 3 may be located completely internal to the flexible walled container 20, completely external, or partially internal. See FIG. 3. In the preferred embodiment, the walled container 20 takes the form of a conventional backpack.

The rigid frame 3 is preferably comprised of at least one vertical wall 4, a base member 5, and a cap member 6. The base member 5 and cap member 6 are located at opposite ends of the vertical wall 4. Both base member 5 and cap member 6 extend away and in a perpendicular direction to the plane of vertical wall 4. See FIG. 6.

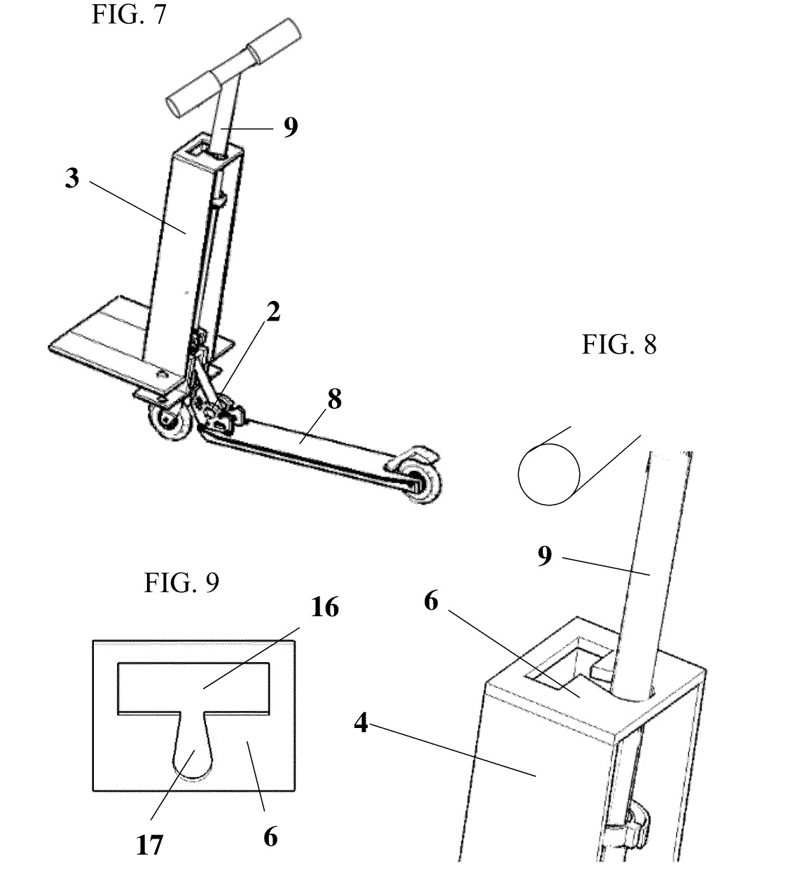

In FIG. 7, the rigid frame 3 is positioned over the steering assembly 9 of the kick scooter 2. FIG. 8 shows the passage of the steering assembly 9 through the cap member 6 of rigid frame 3. This may be accomplished by a removal of portions of the steering assembly 9, or a temporary separation of those portions from one another, to allow the steering assembly 9 to pass through cap member 6. FIG. 9 shows the cap opening 16 located within cap member 6. Cap member 6 is designed to allow steering assembly 9 to pass through in one position, then shift positions into cap recess 17. Cap recess 17 is shaped so as to deformably clip on to steering assembly 9.

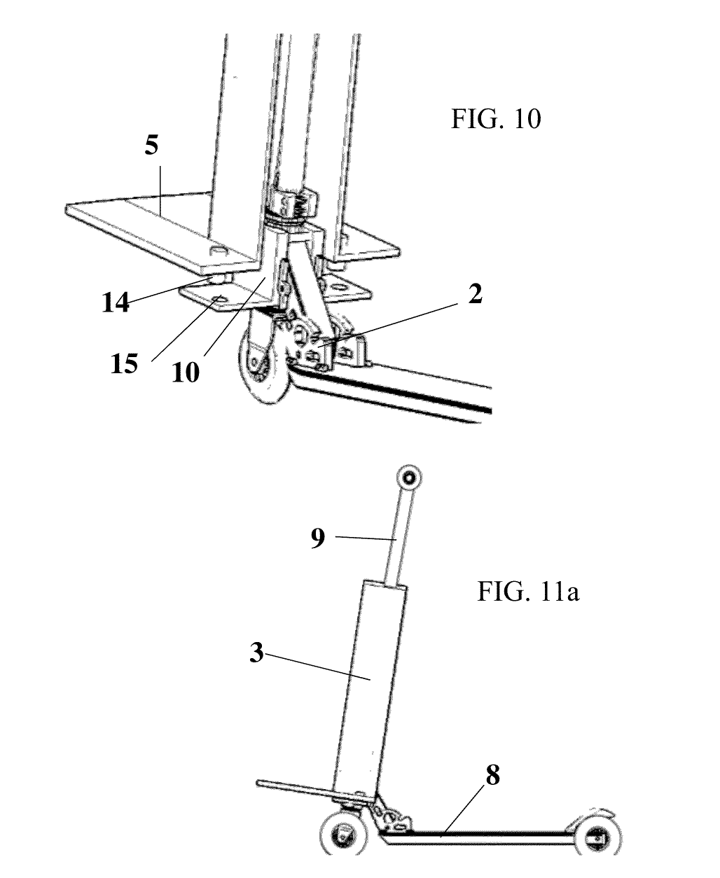

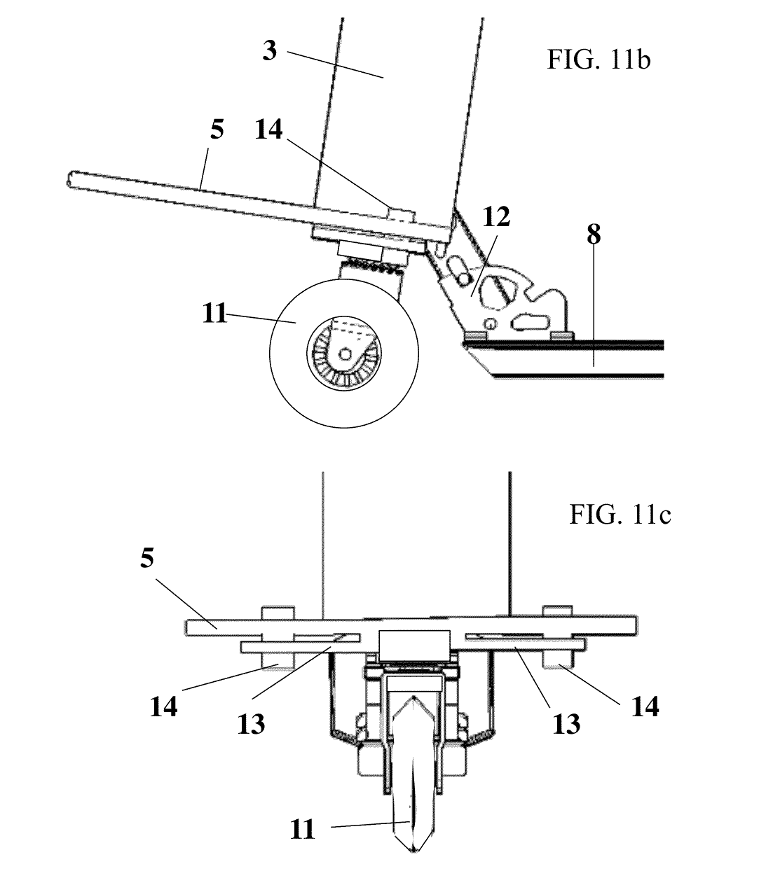

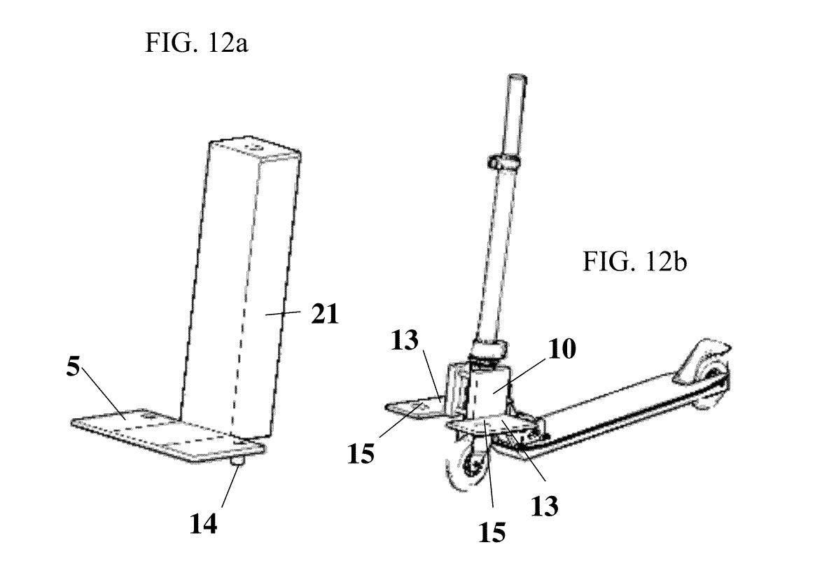

In FIG. 10, rigid frame 3 is in an intermediate position above scooter bracket 10. Base member 5 is comprised of at least one plug 14. Plug 14 extends downwards from base member 5 and is intended to releasably attach to scooter bracket 10 by deformably passing through hole 15. Alternatively, plugs 14 may be located on scooter bracket 10 and extend upwards into holes 15 on base member 5. Plugs 14 may take any shape or configuration known in the art to provide a releasable attachment in this fashion. Scooter bracket 10 is permanently or semi-permanently attached to kick scooter 2. FIGS. 11a-11c show rigid frame 3 in the lowermost position, whereby plug 14 engages scooter bracket 10. In this position base member 5 is located above front wheel 11, thereby supporting the contents of the article carrier without contacting front wheel 11. Rigid frame 3 and base member 5 are also positioned so as to not interfere with a user's access to the scooter latch assembly 12, which is generally operated by hand to provide for a folding of the scooter footboard 8. FIG. 11c shows the horizontal extensions 13 which are integral to scooter bracket 10 and provide a surface for engagement with plugs 14 and assist in the support of base member 5. FIGS. 12a and 12b show an alternate embodiment where plugs 14, and their corresponding holes 15 in horizontal extensions 13, are located further away from the scooter. In further embodiments, the plugs can take a variety of forms to provide for simple releasable attachment between the rigid frame 3 and the scooter bracket 10. Non-limiting alternatives to plugs 14 include any suitable connection mechanisms including: snap-fit plugs, buttons, snap fasteners, plugs and apertures, hook-and-loop fasteners, or magnets.

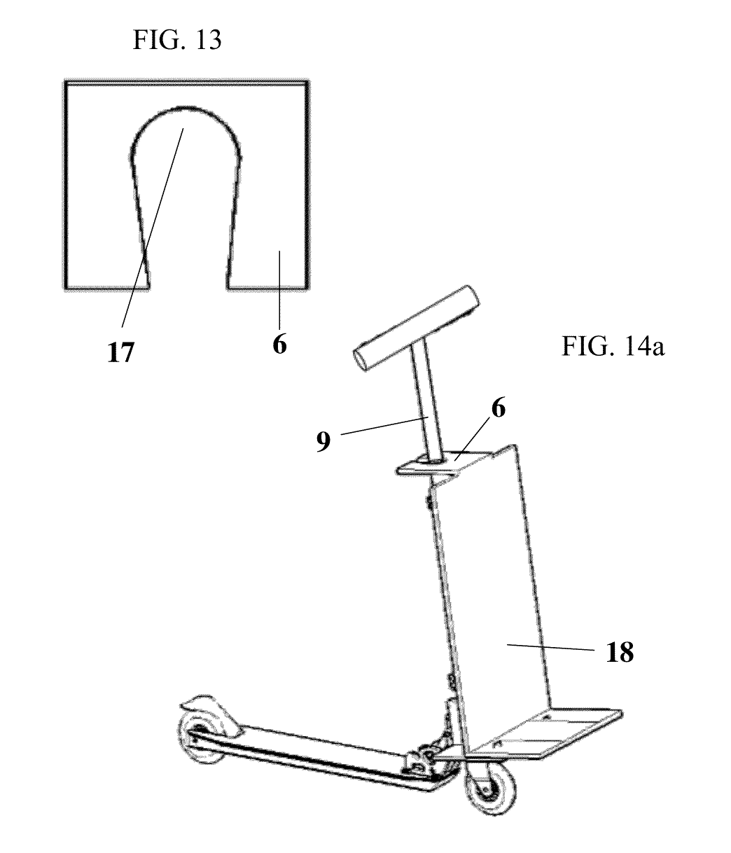

FIG. 13 shows a preferred embodiment of cap member 6 and cap recess 17. Cap recess 17 is shaped so as to allow for a deformable clip attachment to steering assembly 9. To achieve this, cap recess 17 comprises a passage with a narrow entrance leading to a wider opening. The narrow entrance retains steering assembly 9 in the wider opening, until sufficient force is applied to pull them apart. This occurs when the user desires to separate the article carrier from the scooter. While within the wider opening of cap recess 17, steering assembly 9 may rotate along its longitudinal axis to steer the scooter during riding.

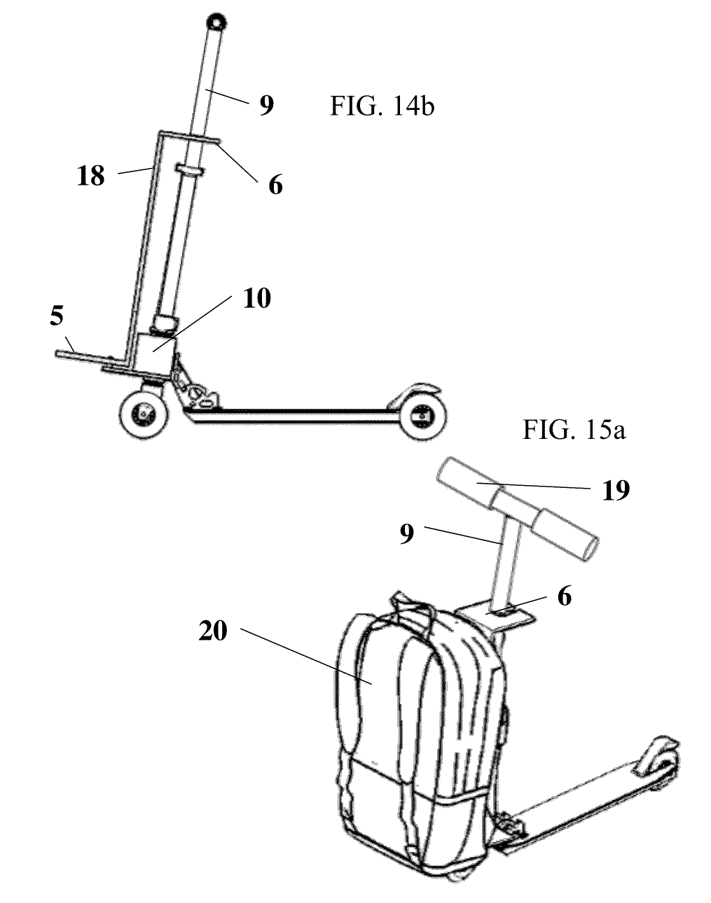

FIGS. 14a and 14b show an embodiment where cap member 6 is attached on to steering assembly 9. In this embodiment, rigid frame 3 is comprised of a single front vertical wall 18. Front vertical wall 18 functions to protect the contents of the article carrier from the steering assembly 9 and to support the upper wall of the article carrier, for aesthetic purposes.

Generally, the rigid frame 3 may be located completely internal to the flexible walled container 20, completely external, or only partially internal. When the rigid frame 3 is completely external or partially internal, the attachment of the article carrier to the scooter may be accomplished by lateral movement between the two or by dropping the article carrier over the steering assembly 9 of the scooter. However, when the rigid frame 3 is located completely internal to the walled container 20, attachment may only be effected by dropping the article carrier over the steering assembly 9. This arrangement further requires openings, either permanently open or selectively closable, at appropriate positions along the walls of the walled container 20, to allow the steering assembly 9 to pass therethrough. This may result in a slightly more difficult installation operation for the user, but can be beneficial for aesthetic reasons.

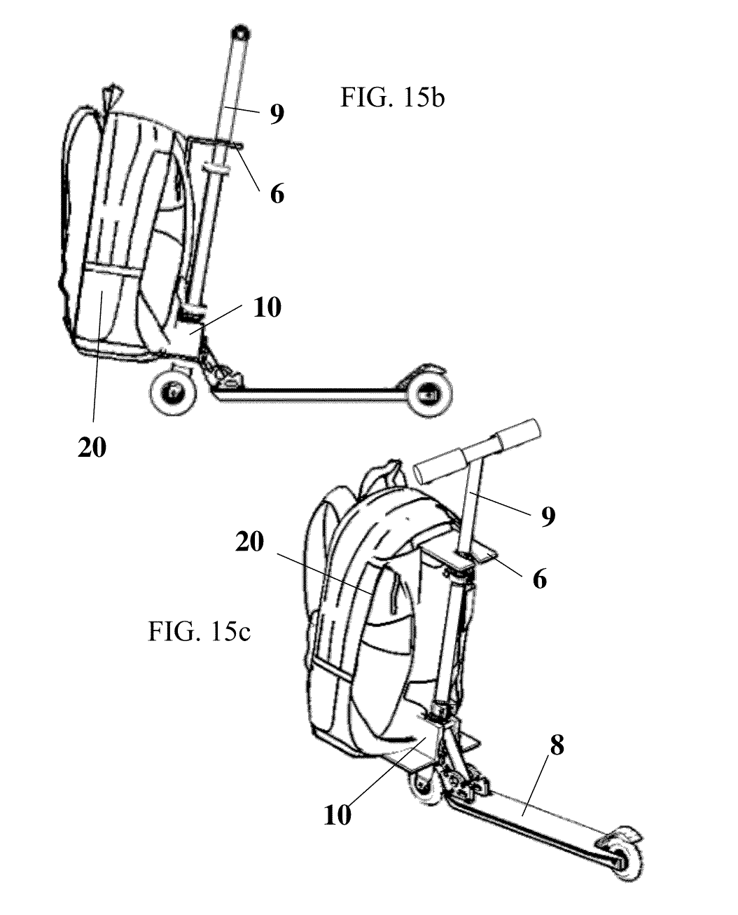

FIGS. 15a-15c show a rigid frame 3 positioned partially internal to flexible walled container 20. In this embodiment, base member 5 is within the container 20, but cap member 6 extends through the wall of the container 20 to interact with steering assembly 9. This is advantageous if concealment of rigid frame 3 is deemed aesthetically pleasing, and allows for clear access to the connection between cap member 6 and steering assembly 9.

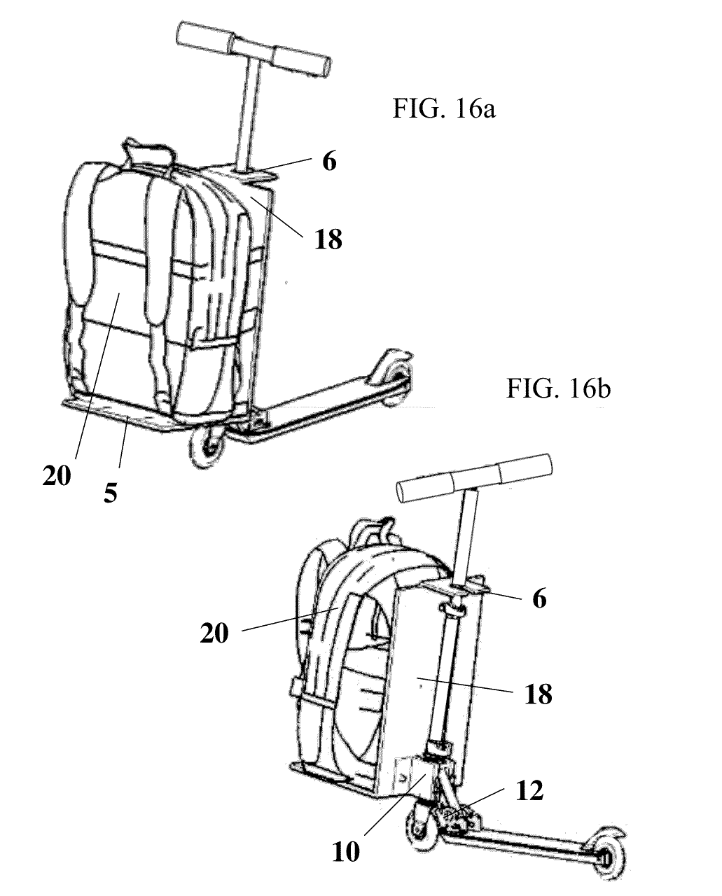

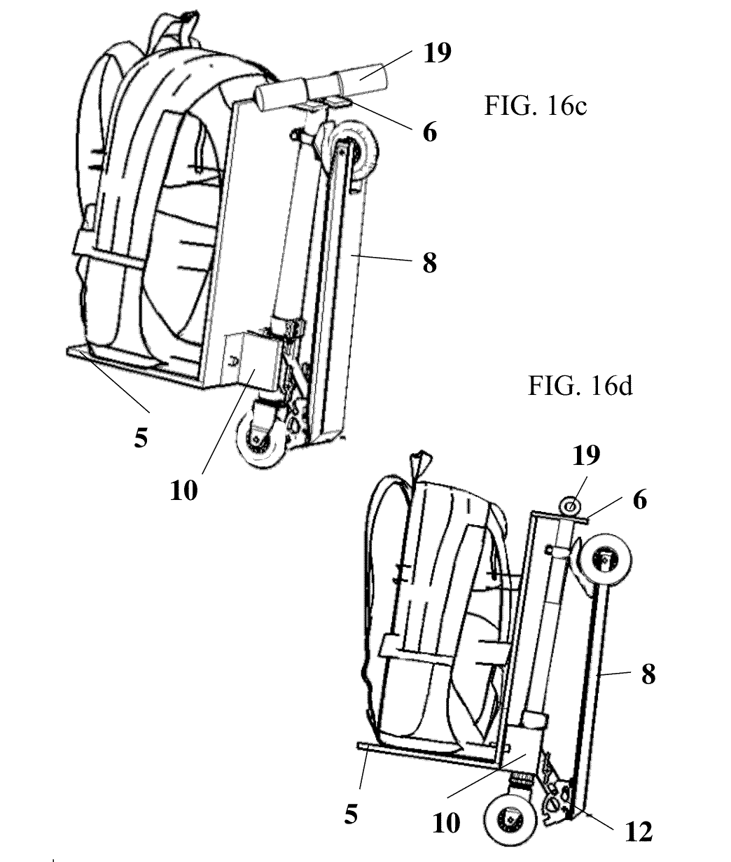

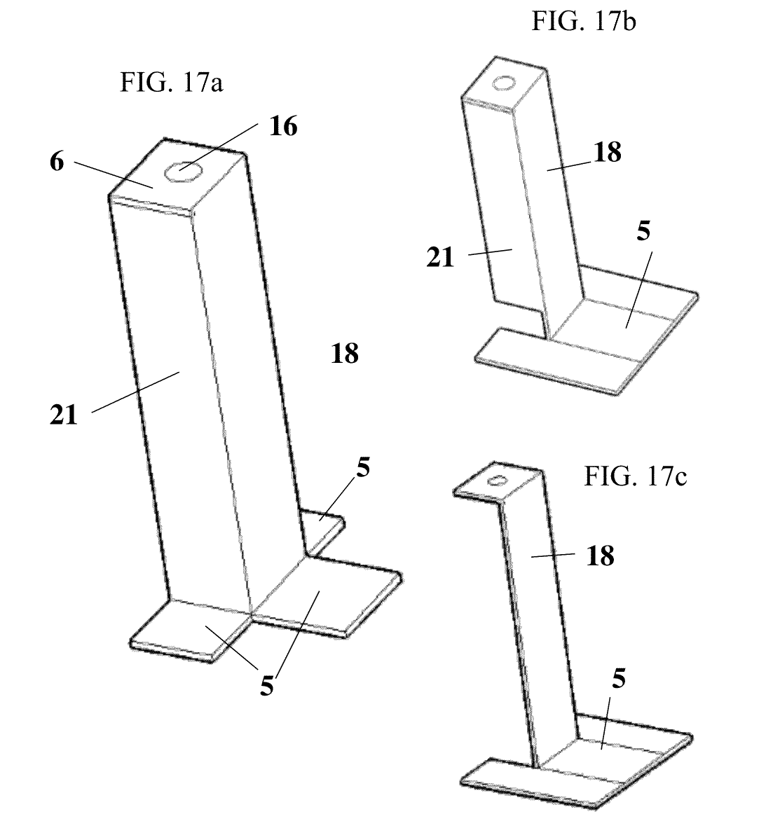

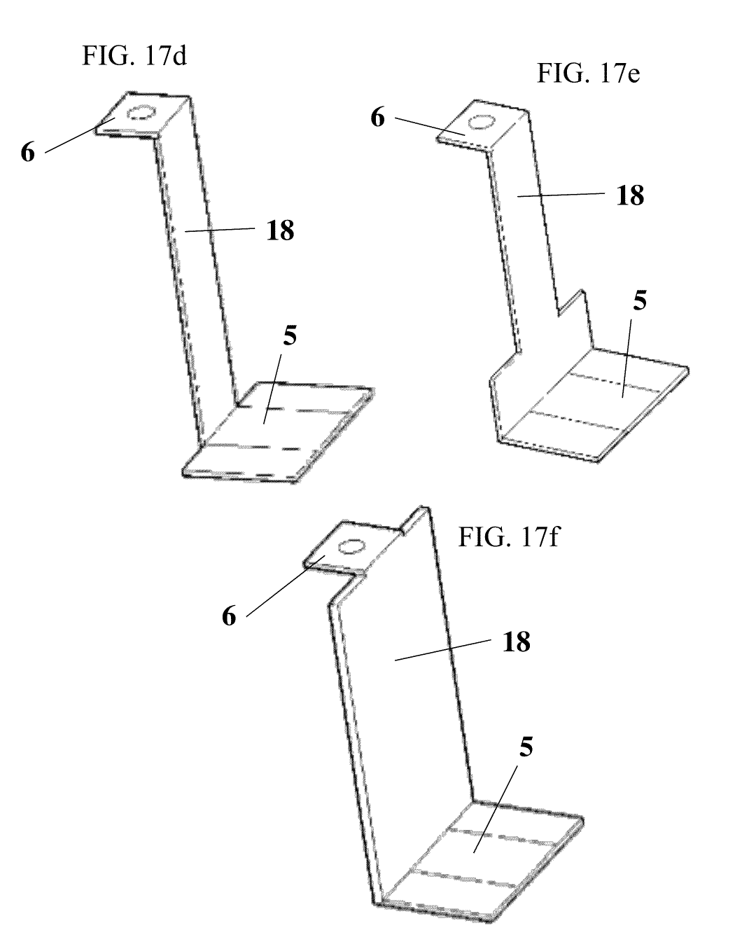

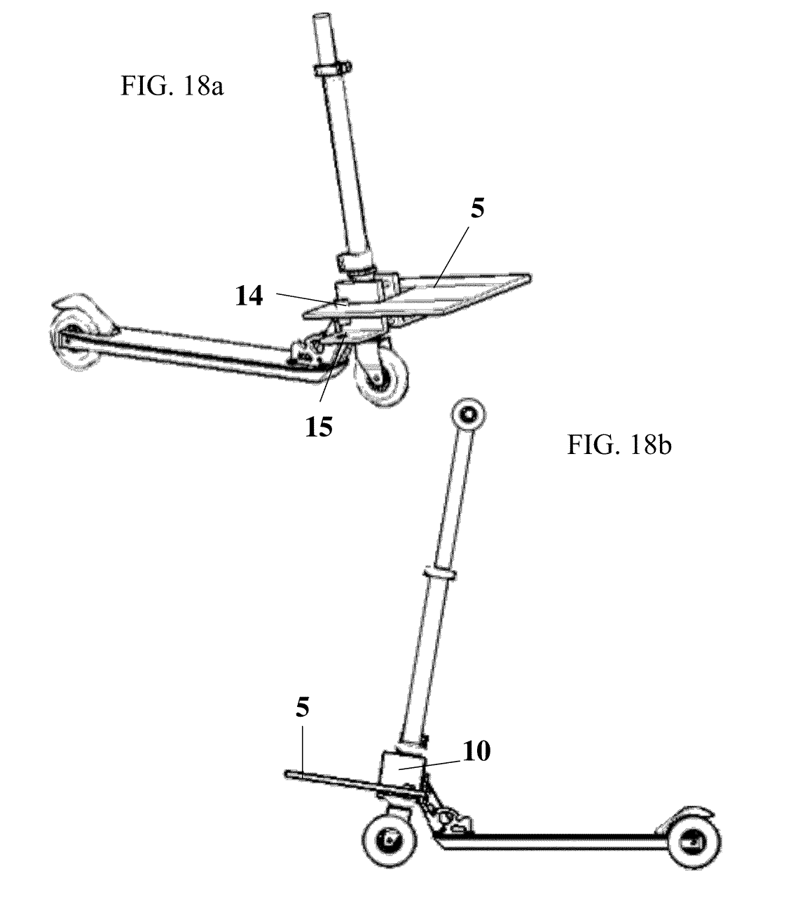

Conversely, FIGS. 16a-16d show rigid frame 3, with front vertical wall 18, cap member 6, and base member 5 completely external to the walled container 20. This is advantageous for manufacturing reasons and allows for clear access to the connection between cap member 6 and steering assembly 9. In this displayed embodiment, scooter bracket 10 is connected to front vertical wall 18 instead of base member 5. A completely external rigid frame 3 thus provides clear access to this connection point as well. FIGS. 17a-17f show various embodiments of vertical wall 18. Side vertical walls 21 may or may not be employed for added rigidity. FIGS. 18a and 18b show a further embodiment where rigid frame 3 lacks a vertical wall 4 and cap member 6, and instead is comprised only of base member 5. This embodiment will provide the functionality of the present invention but is not preferred.

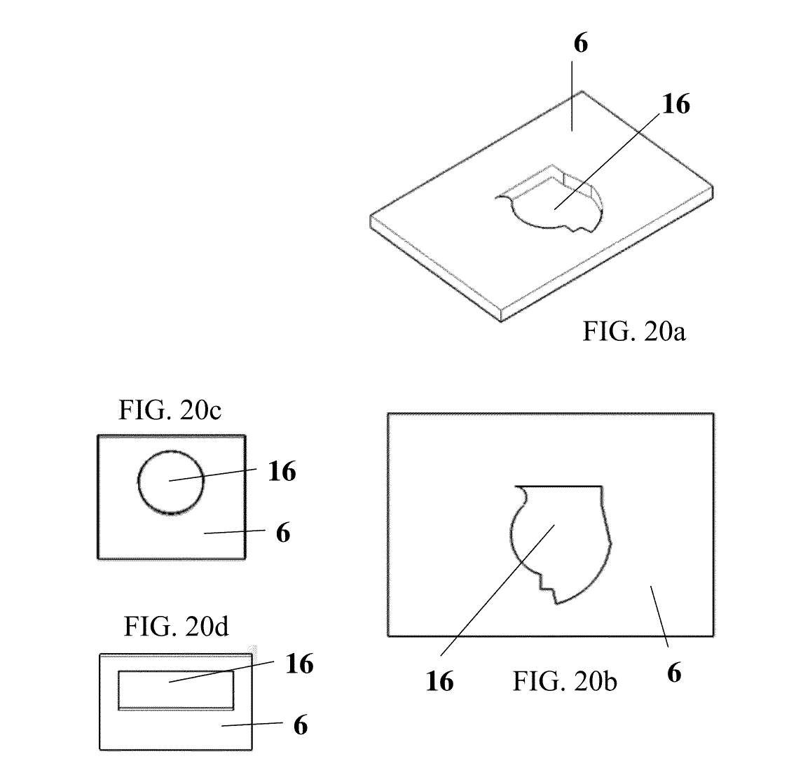

FIGS. 20a-20c show additional embodiments of cap opening 6. These may be selected to accommodate various sizes of kick scooter steering assemblies 9. The cap opening 16 of FIGS. 20a and 20b is intended to allow conventional “quick-release” clamps of steering assemblies 9 to pass through, in the event such scooter is equipped with said clamp. The primary effect of cap member 6 and cap opening 16 is to restrain relative motion between the rigid frame 3 and steering assembly 9 in every direction except vertical translation and steering rotation.

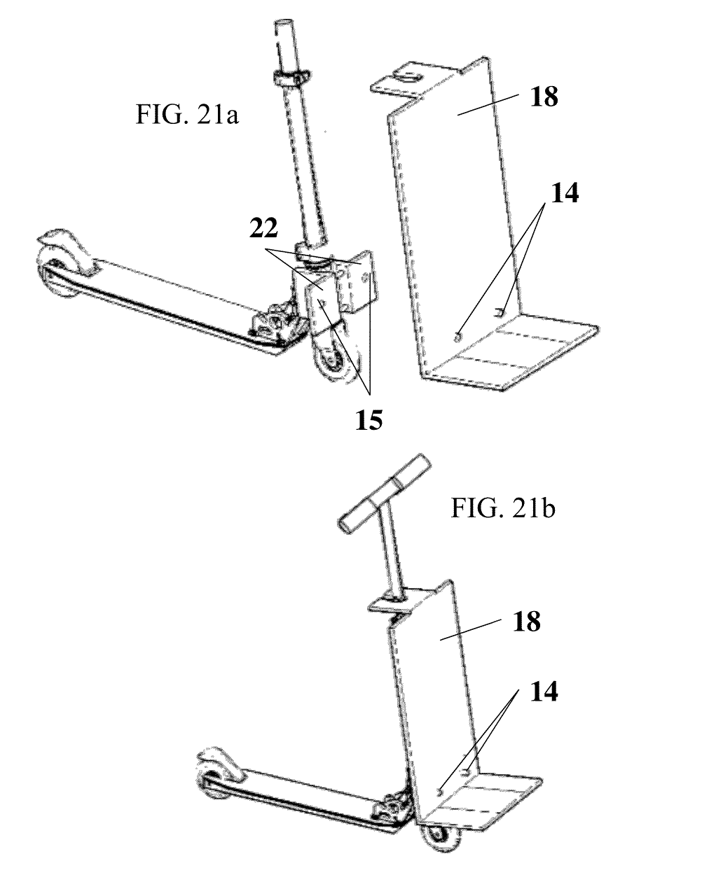

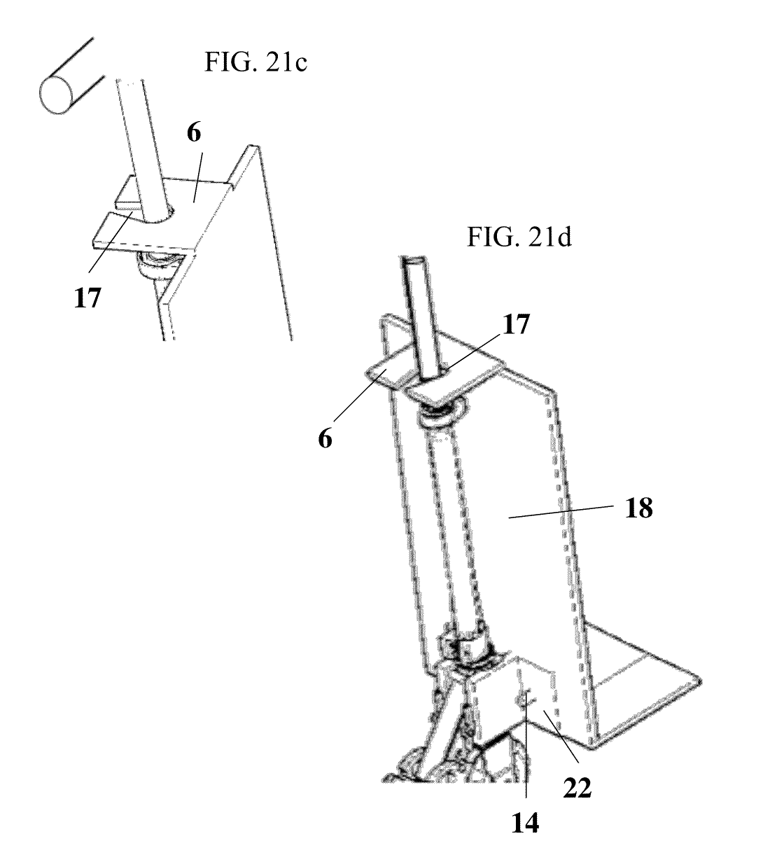

FIGS. 21a-21d show an alternate embodiment of scooter bracket 10 and front vertical wall 18. In this embodiment, scooter bracket 10 is comprised of vertical extensions 22 and corresponding holes 15 on the vertical extensions 22. Vertical extensions 22 are positioned to contact front vertical wall 18 and to permit engagement between plugs 14 and holes 15.

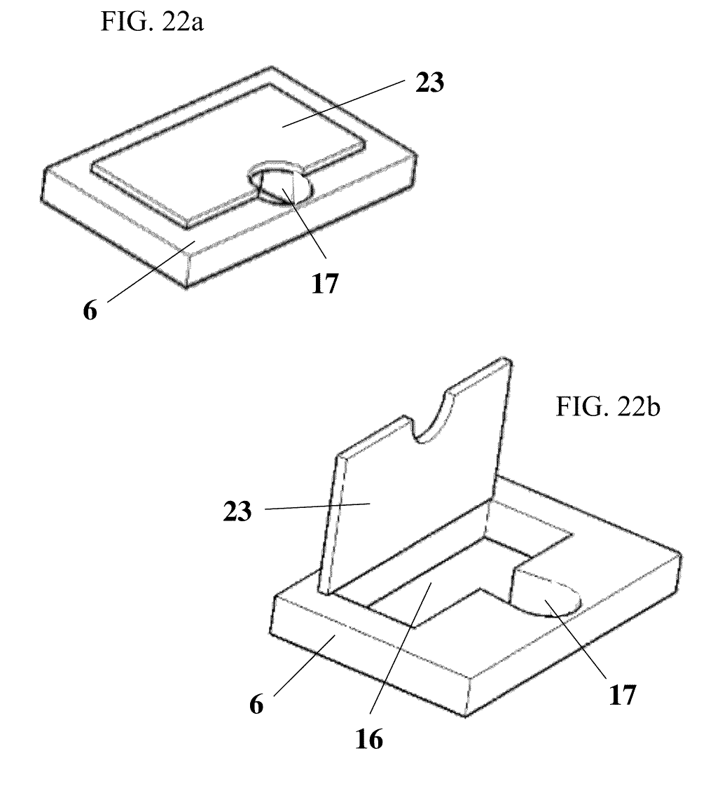

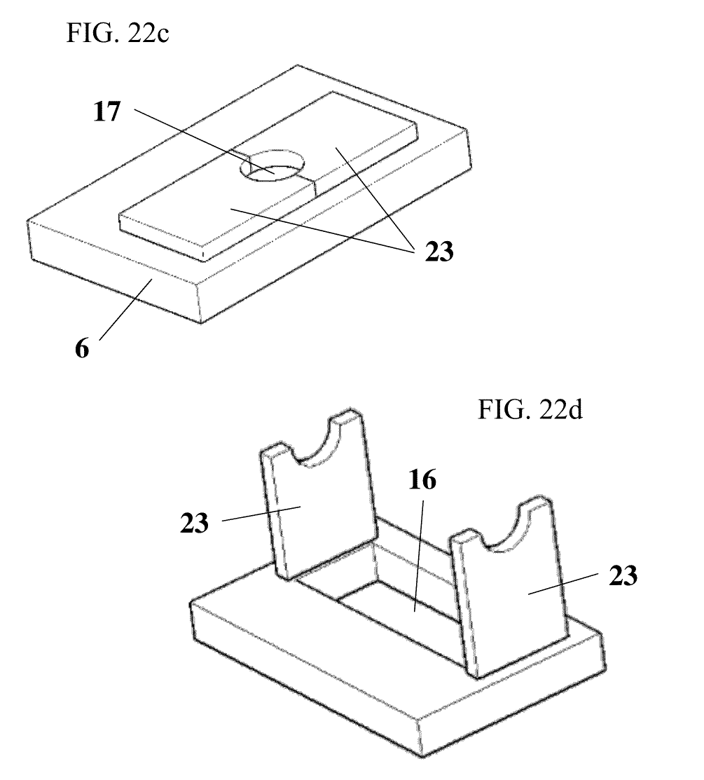

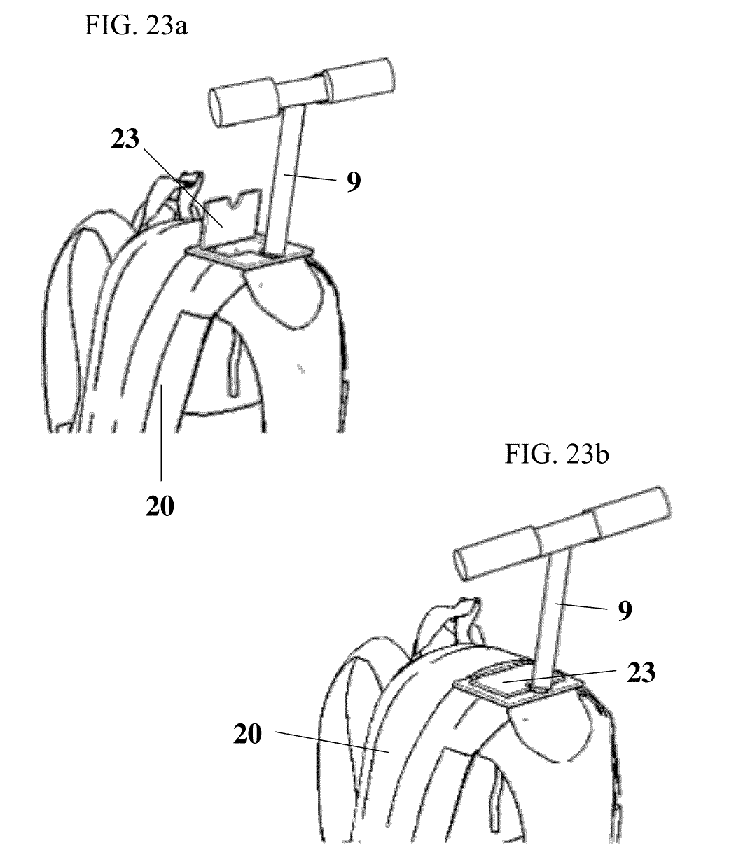

Alternative embodiments of cap member 6 are shown in FIGS. 22a-22d. Here, a flap member 23 is rotatably attached to cap member 6, and functions as a closure for cap opening 16. In these embodiments, there may be single or multiple flap members 23. Generally, flap members have recesses to accommodate the diameter of the steering assembly 9 while within cap recess 17. See FIGS. 22a and 22b. Alternatively, flap members 23 can create cap recess 17 as in FIGS. 22c and 22d. FIGS. 23a and 23b show flap members 23 in open and closed positions relative to the walled container 20.

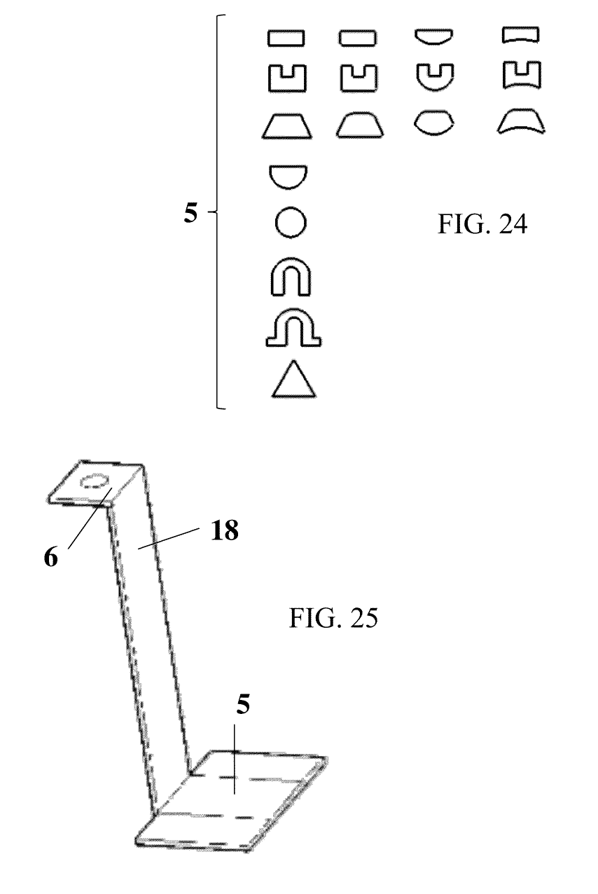

Base member 5 is located near the bottom wall of walled container 20, and may be permanently or semi-permanently attached thereto through any technique known in the art. FIG. 25 shows the basic arrangement of cap member 6, front vertical wall 18, and base member 5. Base member 5 is preferably rectangular in shape, to provide adequate support for the contents of the article carrier. However, FIG. 24 shows various alternate shapes for base member 5. These may be selected based on the shape of flexible walled container 20 or based on the intended contents of the article carrier.

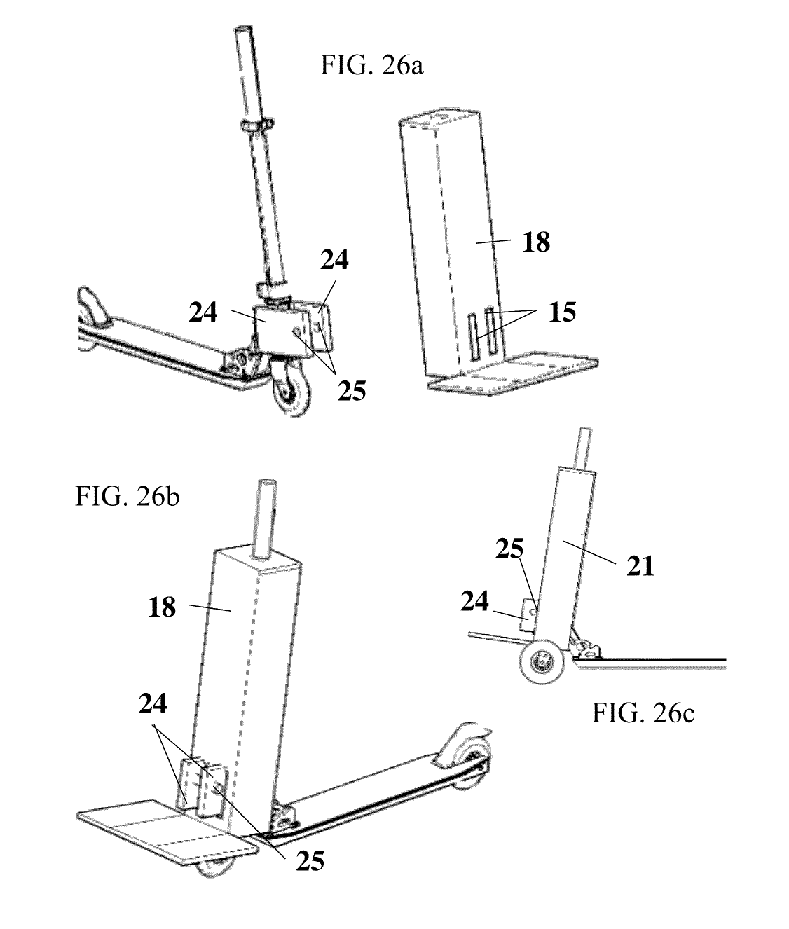

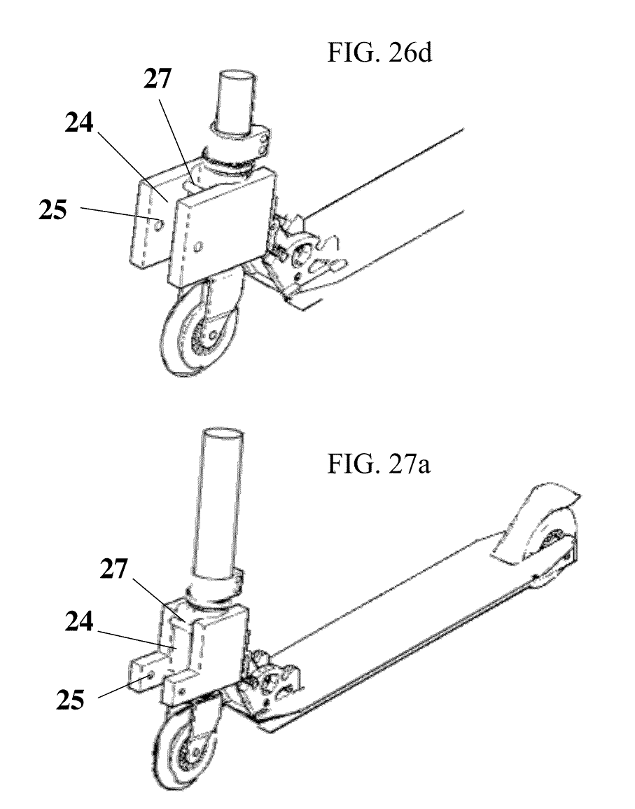

In one embodiment, base member 5 may function as the attachment point to scooter bracket 10 through plugs 14 and holes 15. See FIGS. 10 and 11a-11c. Alternatively, front wall 18 may function as the attachment point to scooter bracket 10 through vertical extensions 22 of scooter bracket 10, plugs 14, and holes 15. See FIGS. 21a-21d. In a further alternate embodiment, scooter bracket 10 itself functions as the attachment point to front wall 18. See FIGS. 26a-26d.

In FIGS. 26a-26d, scooter bracket 10 is comprised of at least one bracket side wall 24. Bracket side wall 24 is positioned to abut a lateral face of the kick scooter and to extend in a forward direction. The forward-most portion of bracket side wall 24 is intended to pass through holes 15 in front vertical wall 18. These forward-most portions are further comprised of holes 25. When bracket side walls 24 are inserted fully through holes 15, holes 25 are accessible on the forward-most face of vertical wall 18. A fastener of any type known in the art can then be placed across side walls 24, through holes 25, to prevent the bracket side walls 24 from retreating out of holes 15.

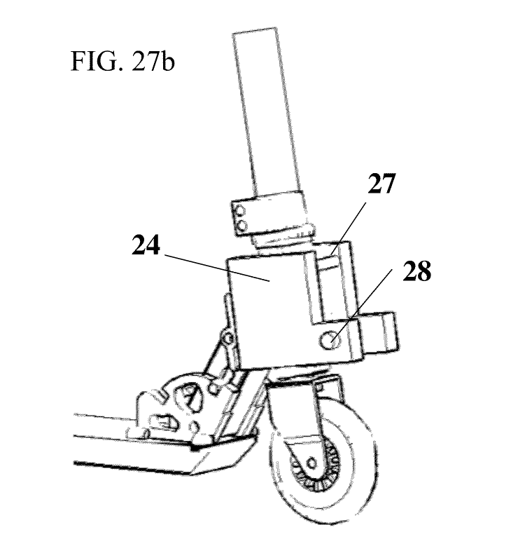

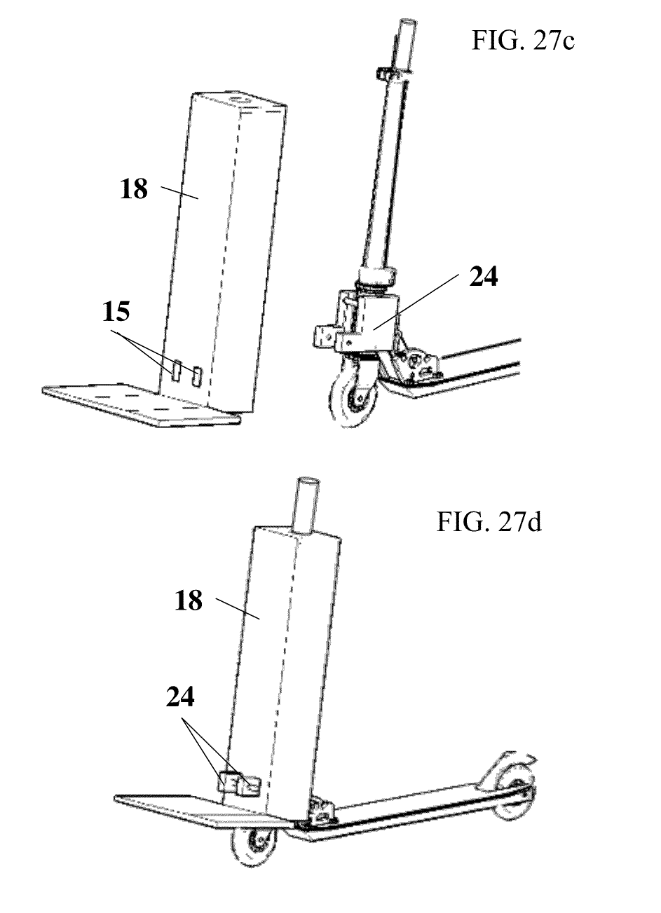

Alternatively, bracket side walls 24 can be shaped to minimize the surface area of the forward-most portion that extends through holes 15 in front vertical wall 18. See FIGS. 27a-27f. Again, once the forward-most portions pass through, they can be secured using any known fastener in the art, or individual fasteners for each bracket side wall, as shown in FIGS. 27e and 27f. To release this connection the fastener can be removed by the user permitting bracket side walls 24 to leave holes 15. Alternatively, the forward-most portions of bracket side walls 24 may include bumps 28. See FIG. 27b. Bumps 28 function to contact and deform during insertion through holes 15, then expand on the forward-most side of vertical wall 18, thereby preventing a similar retreat of bracket side walls 24 from holes 15 during use.

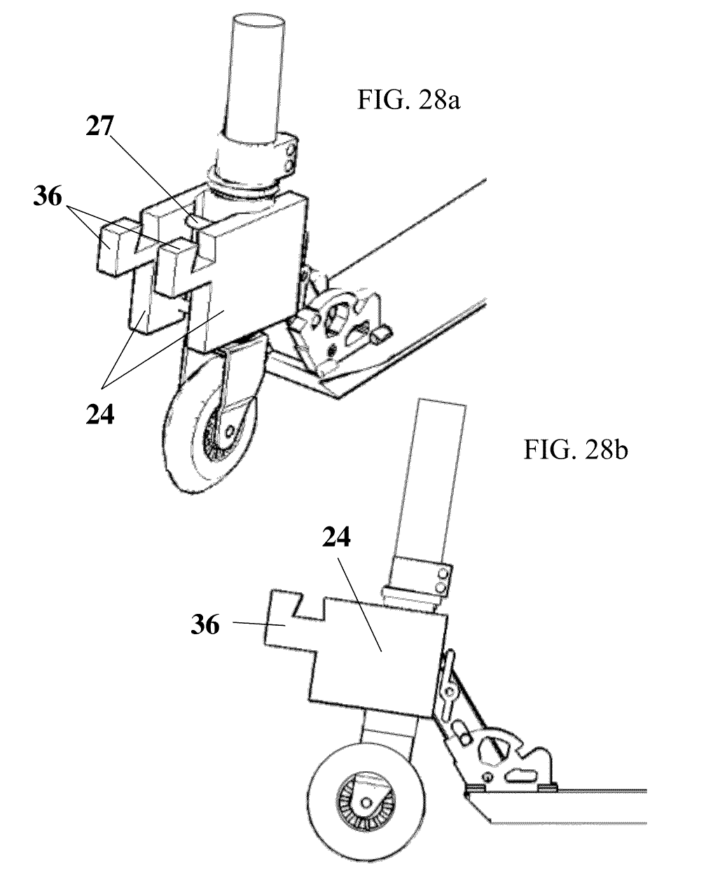

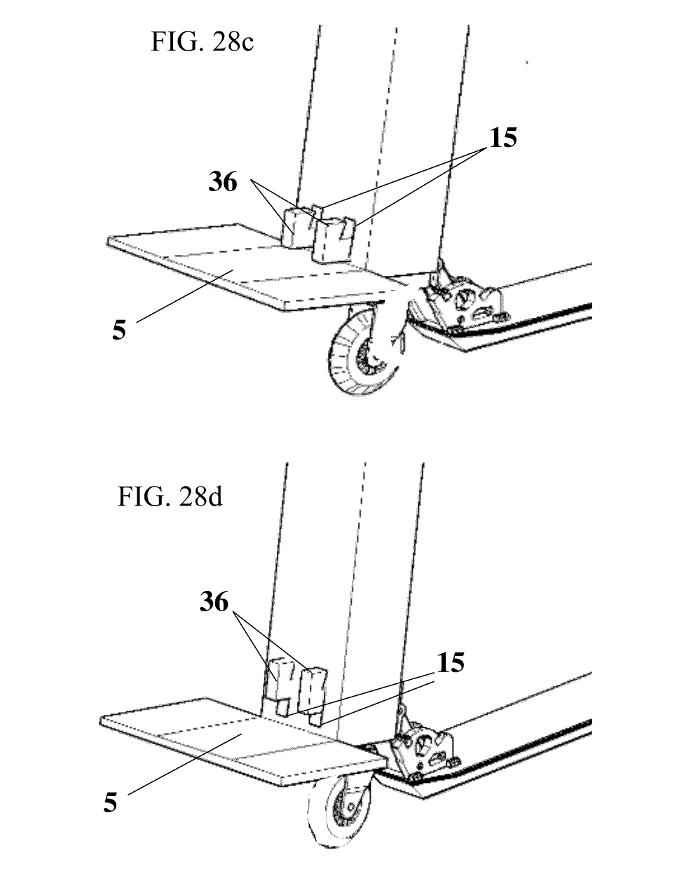

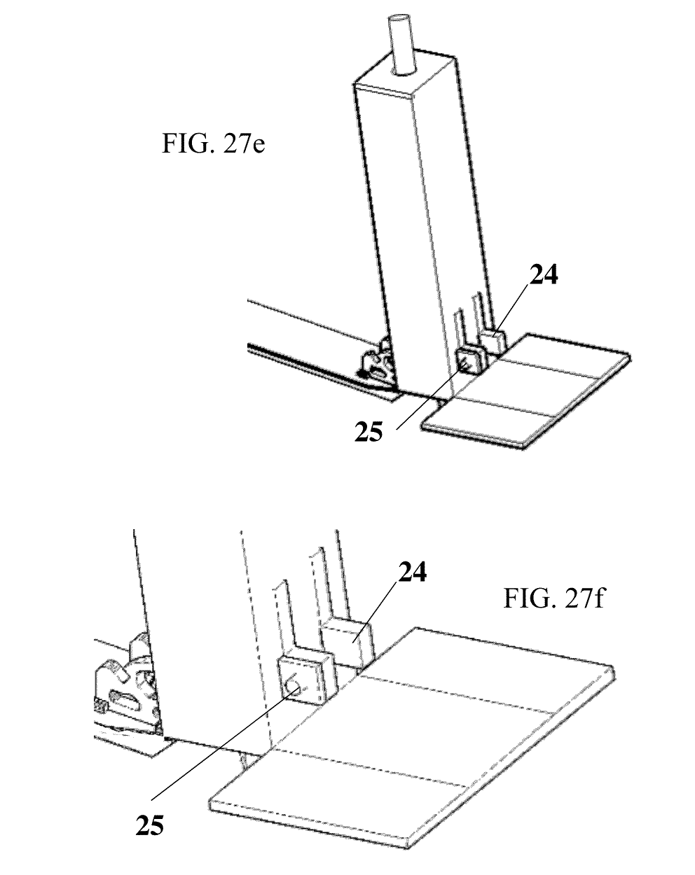

In a further alternate embodiment, the forward-most portions of bracket side walls 24 are shaped into angular extensions 36. See FIGS. 28a-28d. These angular extensions 36 are shaped to pass through holes 15 in front vertical wall 18 in a first direction, then translate in a second perpendicular direction to engage the perimeter of hole 15. If this engagement is of sufficient frictional or deformable strength, no fasteners are required to secure the rigid frame 3 to scooter bracket 10 in this embodiment.

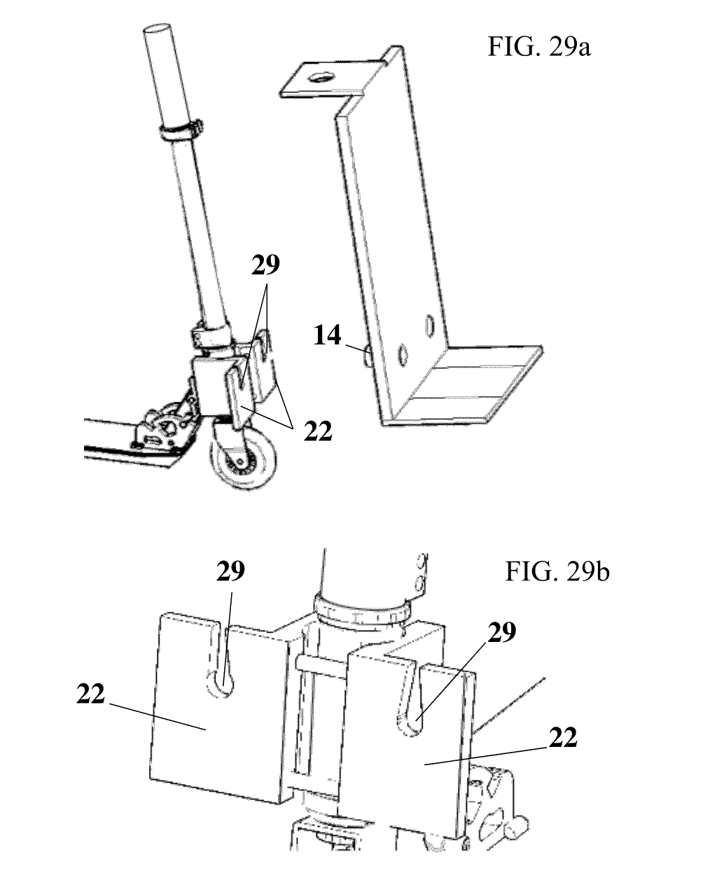

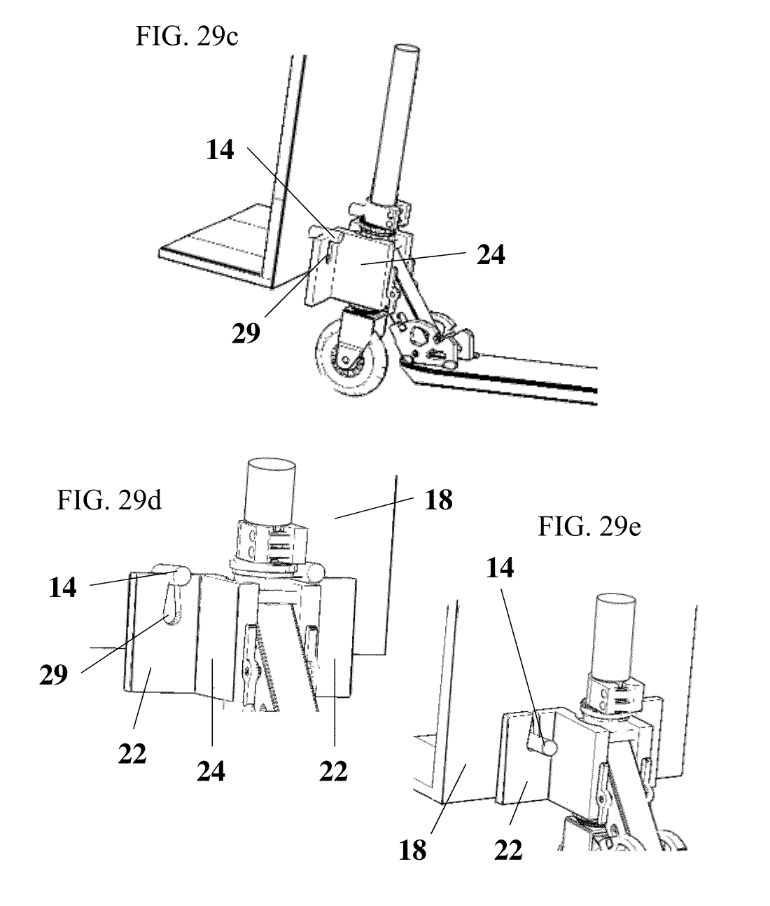

FIGS. 29a-29e show a further embodiment whereby pegs 14 are located on front vertical wall 18 and scooter bracket 10 is comprised of vertical extensions 22. Along any edge, but preferably the top, of vertical extension 22 is a bracket recess 29. Bracket recess 29 is intended to receive peg 14 in a sliding relationship, whereby peg 14 deforms the narrow opening of bracket recess 29 before reaching a more stable wider opening. At this point pegs 14 are secured to vertical extensions 22. See FIG. 29e.

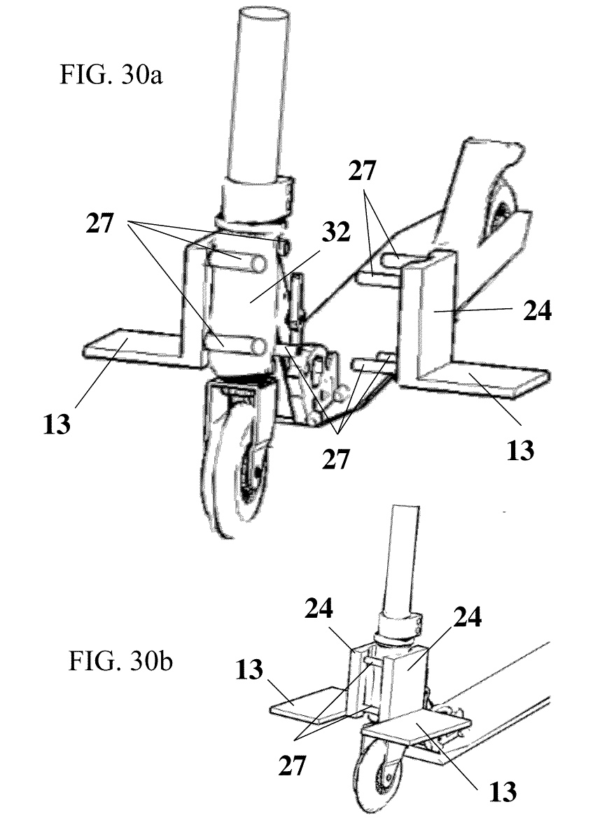

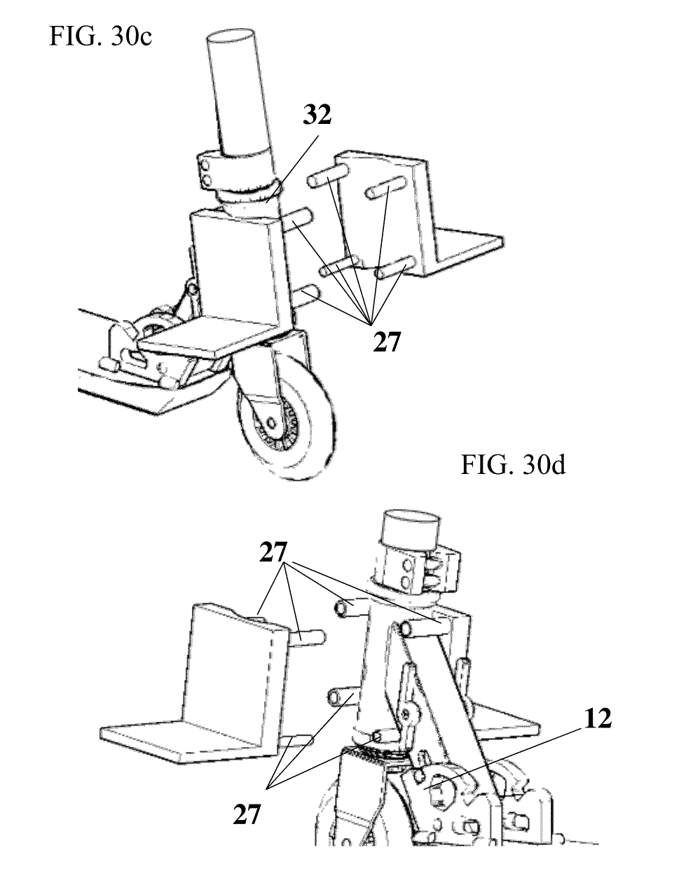

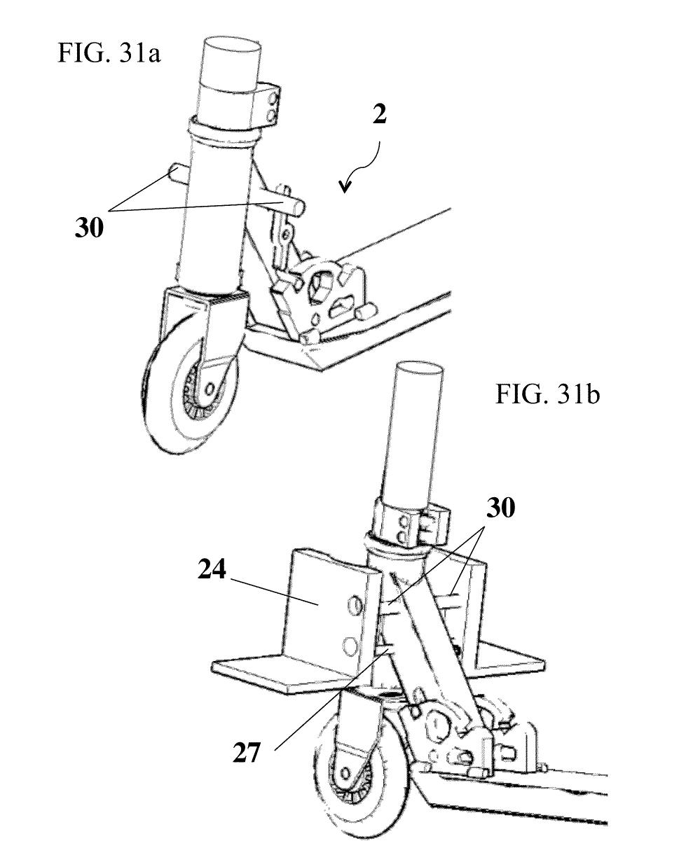

FIGS. 30a-30d show the preferred embodiment of scooter bracket 10. Preferably, scooter bracket 10 is comprised of two, nearly identical halves. Each half includes a bracket side wall 24, and optionally a vertical 22 or horizontal extension 13. Each half is placed around a portion of the scooter. Preferably this portion is the hub 32, which is herein defined as the location at which a joint to permit steering of the scooter is located. Bracket side walls 24 are placed on lateral sides of the hub 32, and then permanently or semi-permanently fastened to one another through bracket connectors 27. This may include male and female counterpart ends to bracket connectors 27, or may include the use of tension fastener known in the art, placed through bracket connectors 27. Bracket connectors 27 may be located above and below, in front of, and behind portions fo the scooter hub 32.

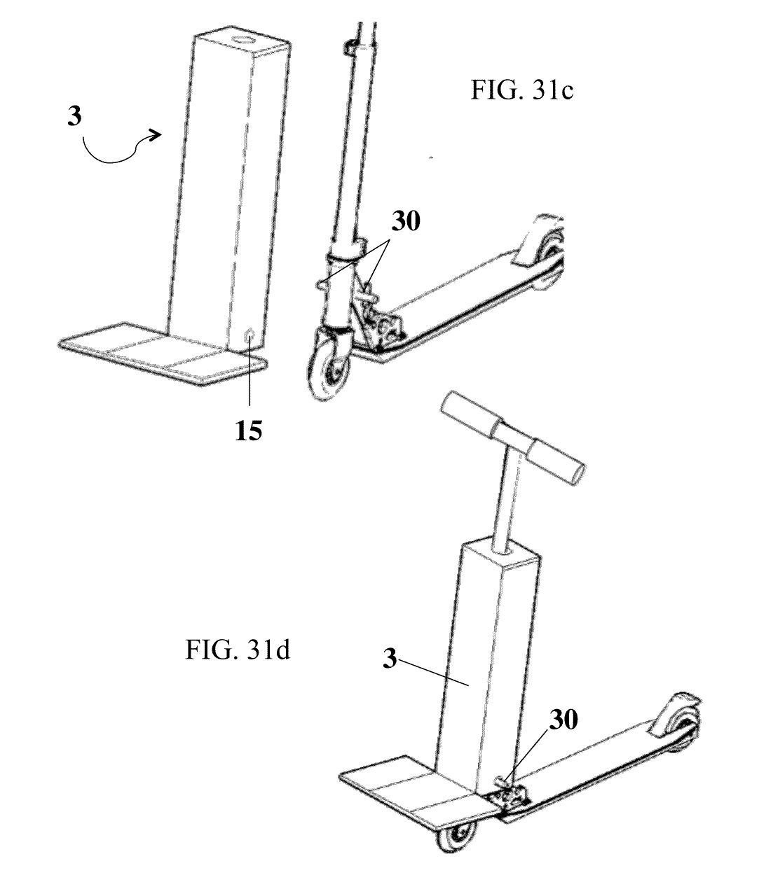

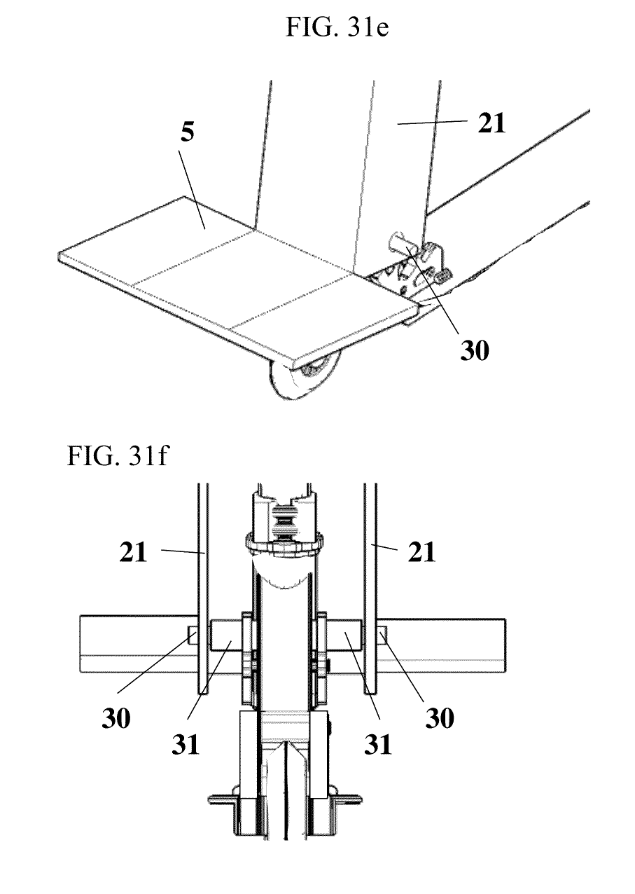

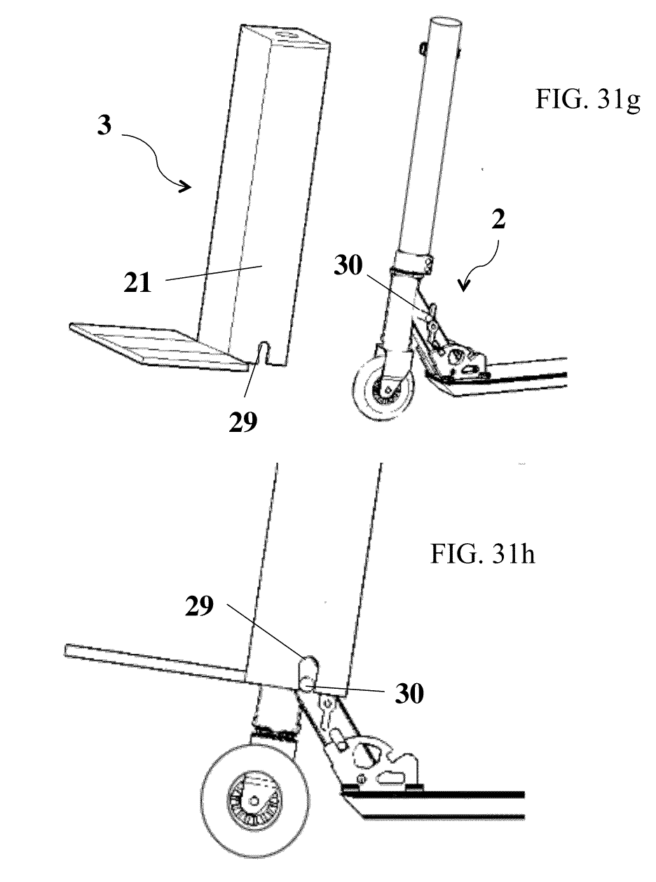

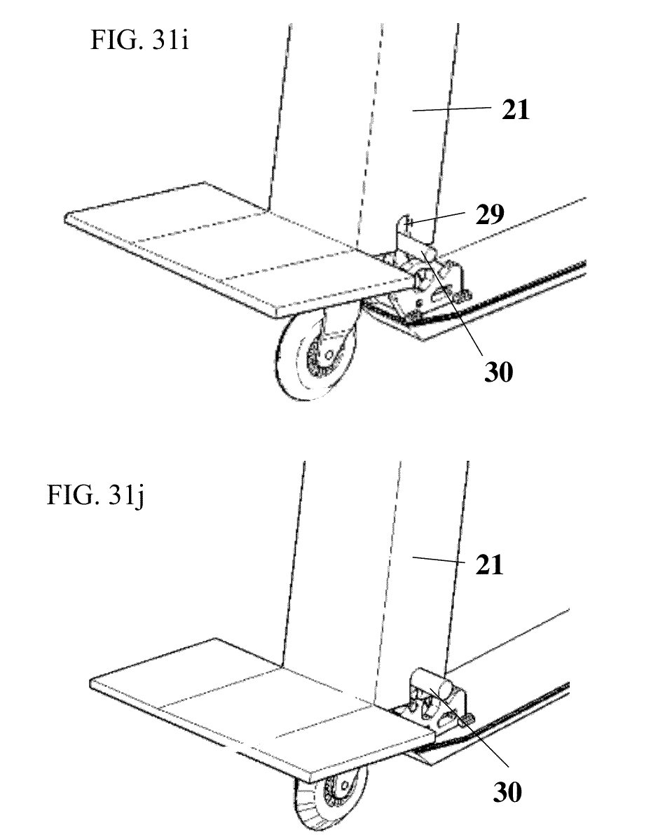

Generally, at least two bracket connectors 27 are needed for adequate attachment to the scooter hub 32. But, preferably there are three, placed in front of, behind and above, and below and behind the scooter hub. Four bracket connectors 27 may be needed for more stressful applications of the device. Scooter bracket 10 is also shaped so as to avoid interference with scooter latch mechanism 12, which operates to unlock the footboard 8 for rotation, or folding. FIGS. 31a and 31b show further alternate embodiment, wherein at least one peg 30 is integral to the scooter to function in a manner similar to bracket connectors 27. Use of a peg 30 may assist a user in the placement of scooter brackets 10 onto the scooter during installation. Alternatively, pegs 30 may connect directly to the rigid frame 3 through holes 15 or recesses 29. See FIGS. 31c-31j. If pegs 30 are used as in this embodiment, it is preferred that spacers 31 be employed to restrict lateral movement of the rigid frame 3 along pegs 30. See FIG. 31f.

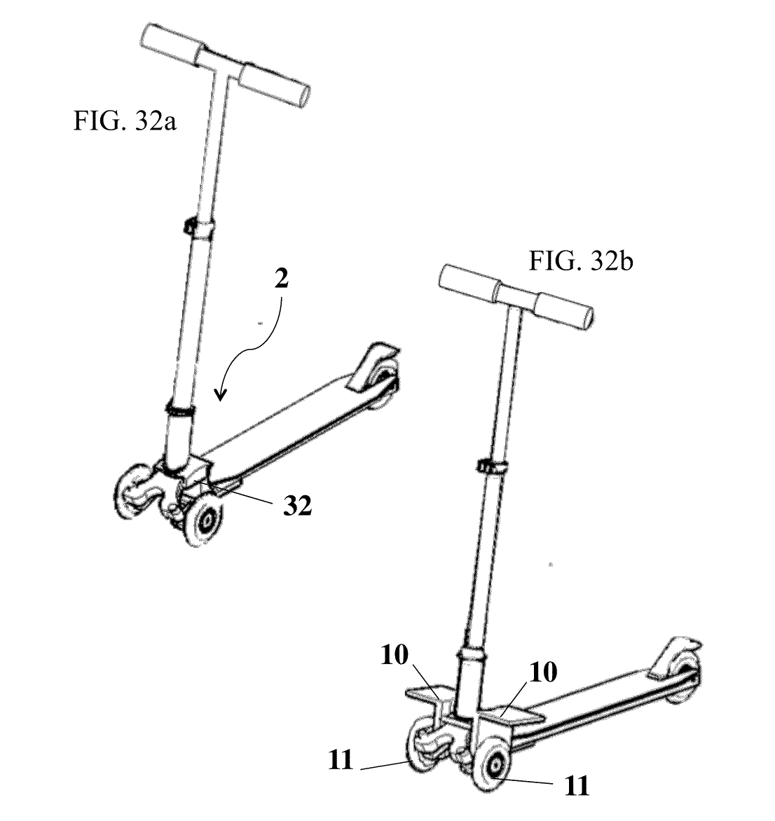

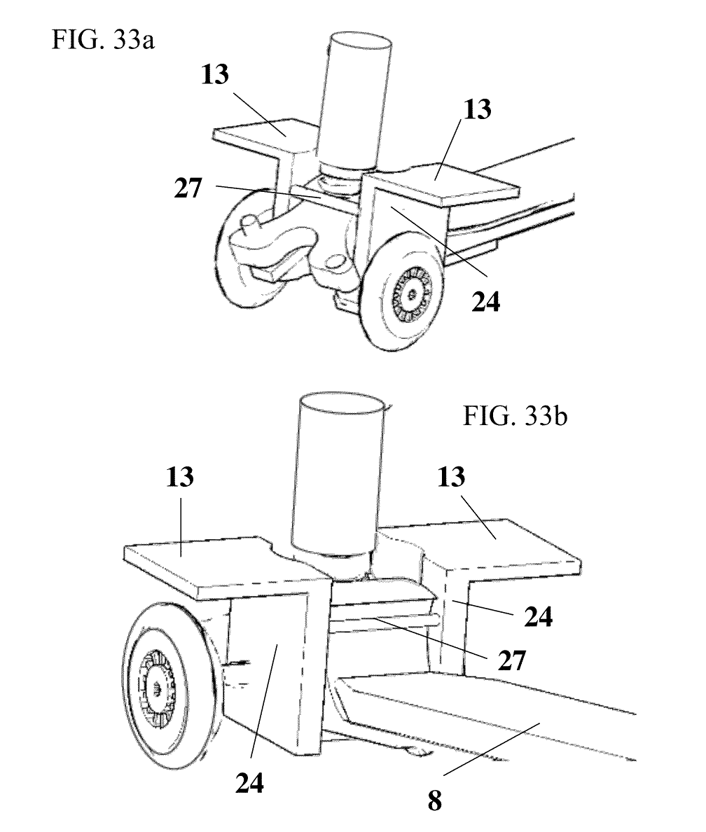

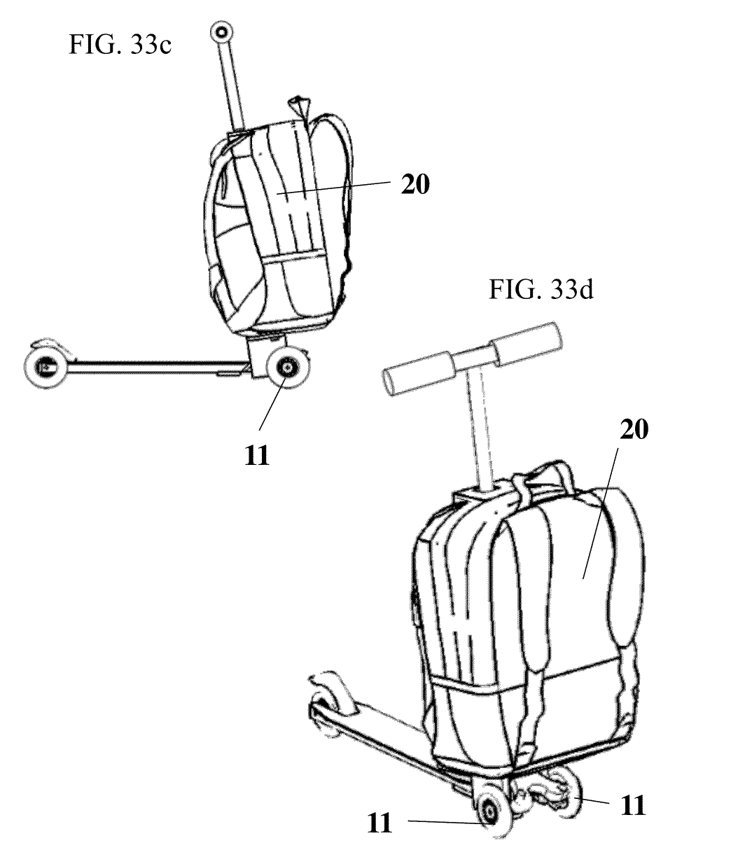

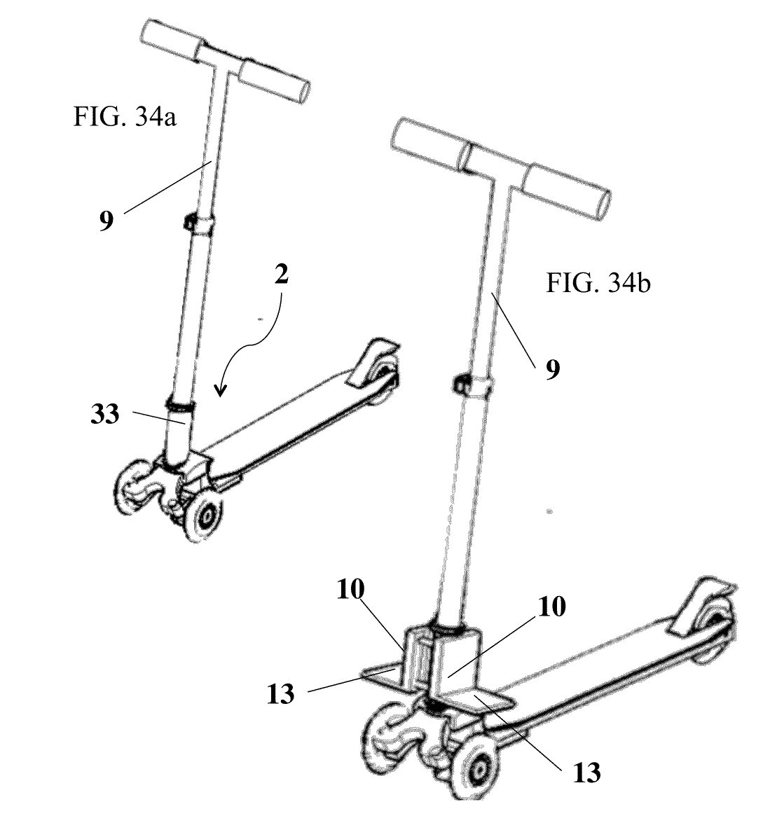

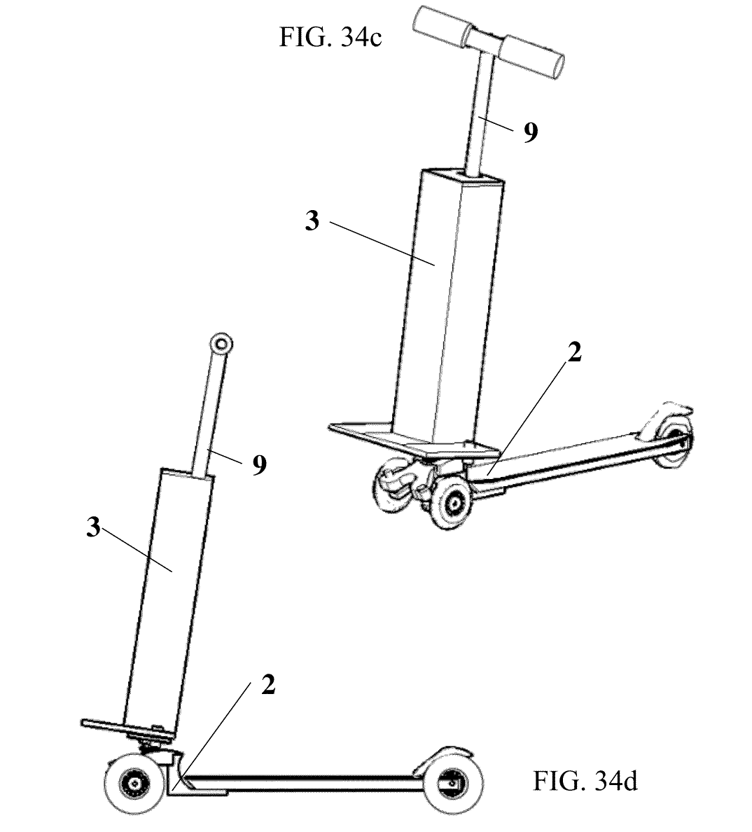

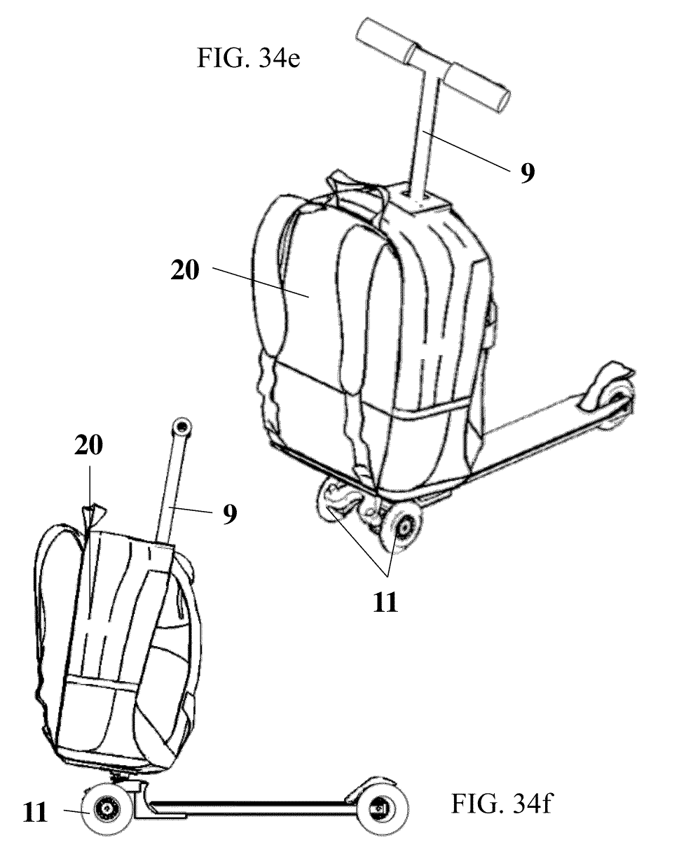

The above embodiments have been primarily intended for use on two wheeled scooters. However, may conventional kick scooters 2 have three wheels, two front wheels 11 and one rear. See FIGS. 32a and 32b. To accommodate the presence of two front wheels 11, the inventive system preferably includes a scooter bracket 10 be placed around the hub 32 of the kick scooter 2. See FIGS. 33a and 33b. The scooter bracket 10 preferably includes bracket side walls 24 and horizontal extensions 13, and a suitable number of bracket connectors 27. The horizontal extensions 13 preferably connect with base member 5 as in arrangements described above. In this fashion, horizontal extensions 13 are above the front wheels 11 and prevent any contact with base member 5 or the contents of the article carrier. FIGS. 33c and 33d show the fully assembled appearance of this embodiment. FIGS. 34a-34f show an alternate embodiment for a three wheeled scooter, wherein the scooter bracket 10 is connected to a portion of the steering assembly above hub 32. See FIG. 34b. This may be preferable if the geometries of the particular scooter hub 32 are too complicated to permit an adjacent placement of bracket side walls 24. Again, horizontal extensions 13 are located above front wheels 11 to prevent any undesirable contact therewith.

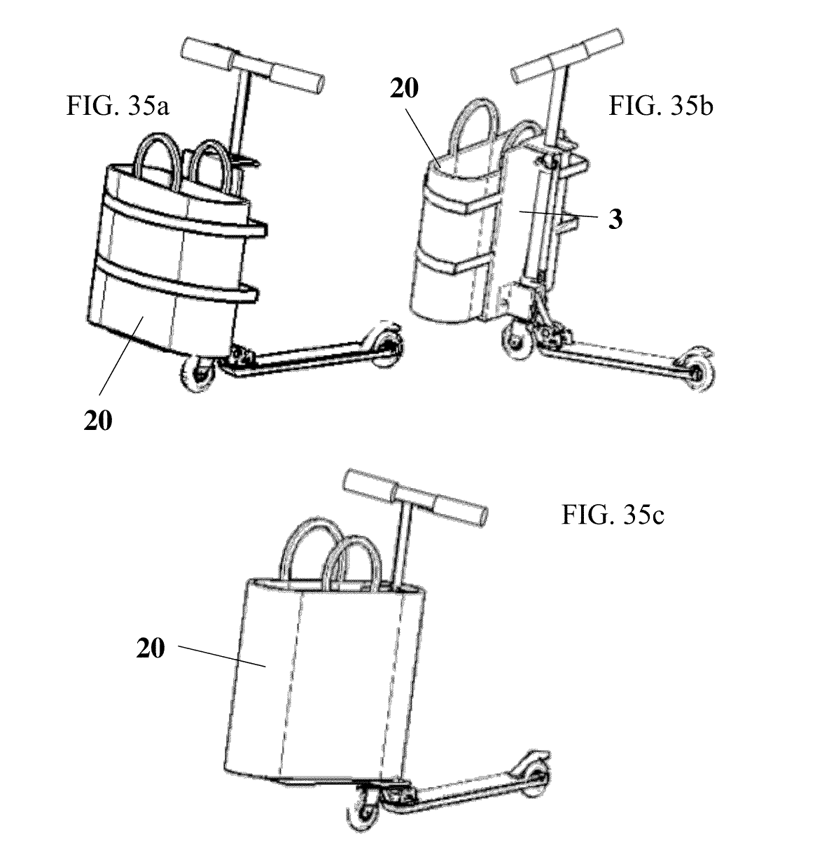

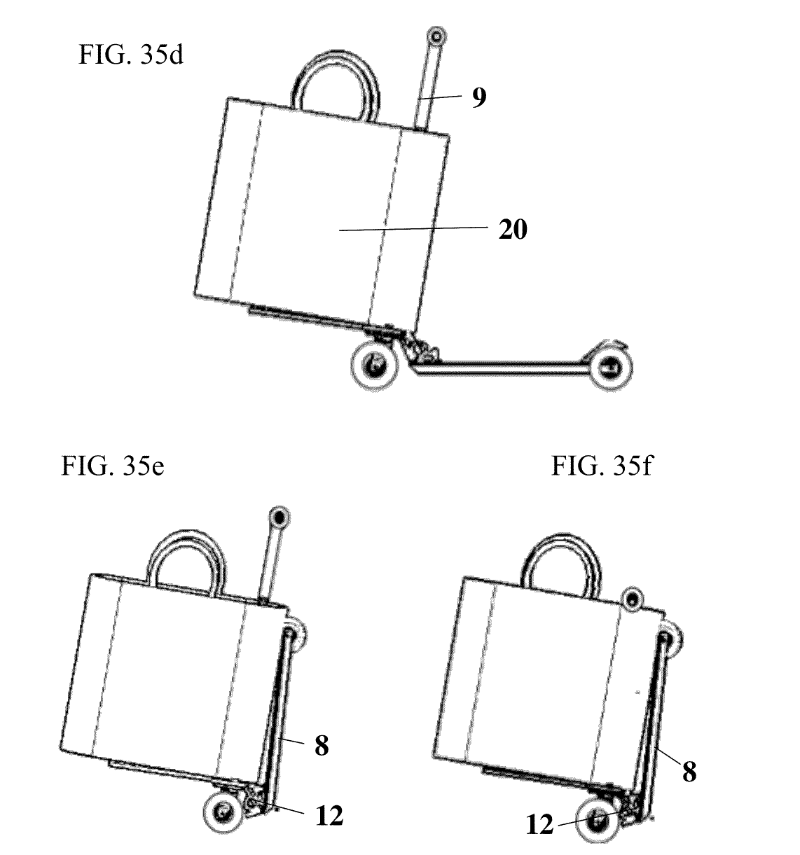

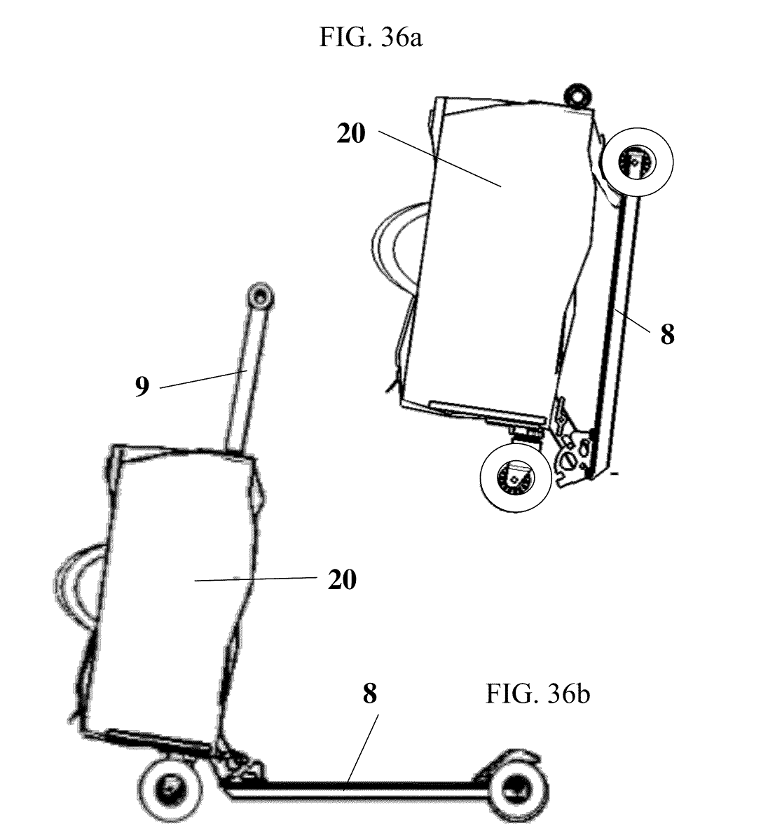

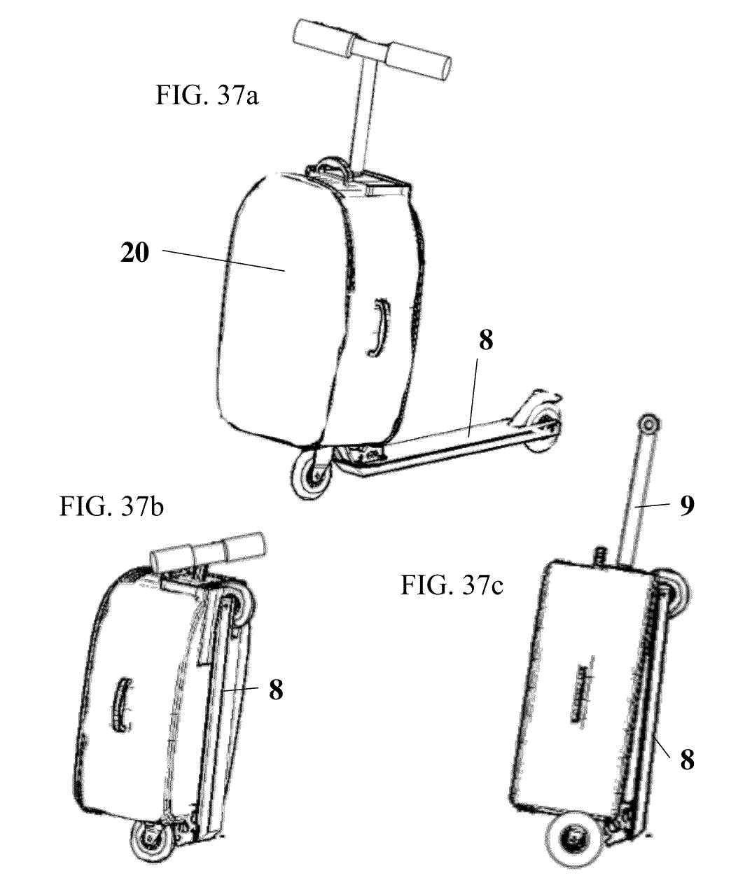

As described above, the inventive system provides a means for releasable attachment of an article carrier to a kick scooter, in a fashion that allows a rider to ride the combination device as a scooter, or carry as an article carrier. The inventive system further provides for interchangability between different article carriers and scooters. For example, a longer journey may call for a larger-wheeled scooter; or if sizeable loads are to be carried, a more voluminous article carrier. FIGS. 35a and 35b show an embodiment where tote bag has replaced the backpack as the walled container 20. This walled container 20 may attach to the rigid frame 3 in an external fashion, as in FIGS. 35a and 35b. Or, preferably, a completely internal fashion as shown in FIGS. 35c-35f. In either arrangement, the rigid frame 3 releasably attaches to a scooter bracket 10 as in any of the embodiments described above. FIGS. 36a and 36b show a further alternate walled container 20, taking the form of a duffel bag. FIGS. 37a-37c show a further alternate walled container 20, taking the form of a rigid suitcase. It is within the spirit of the invention that each of these walled containers 20 can be quickly and easily switched out, or interchanged, with another through the releasable connections between the rigid frame 3 and the steering assembly 9 and scooter bracket 10.

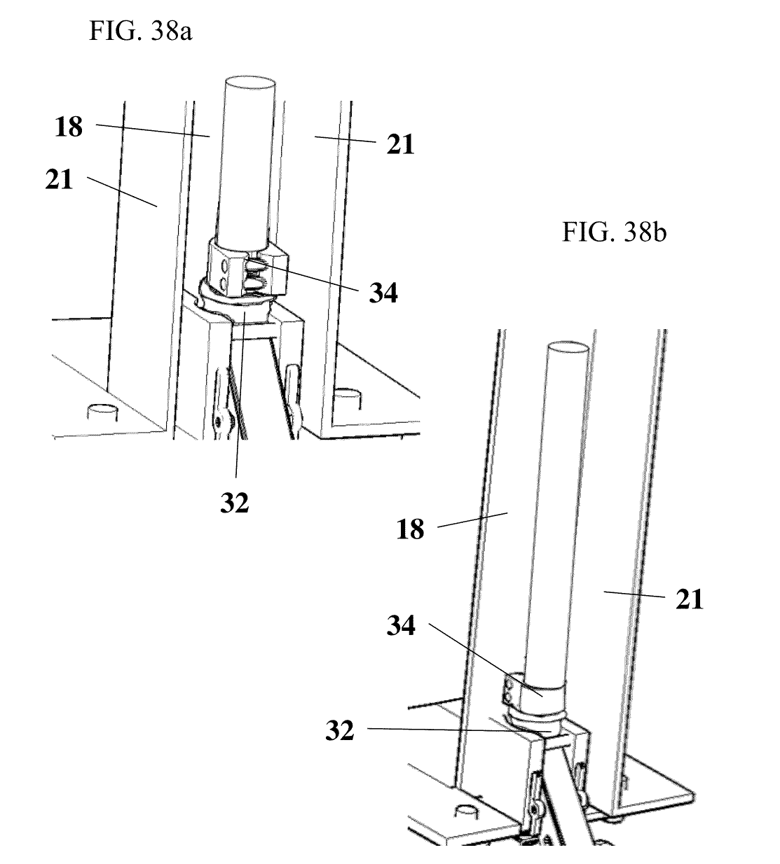

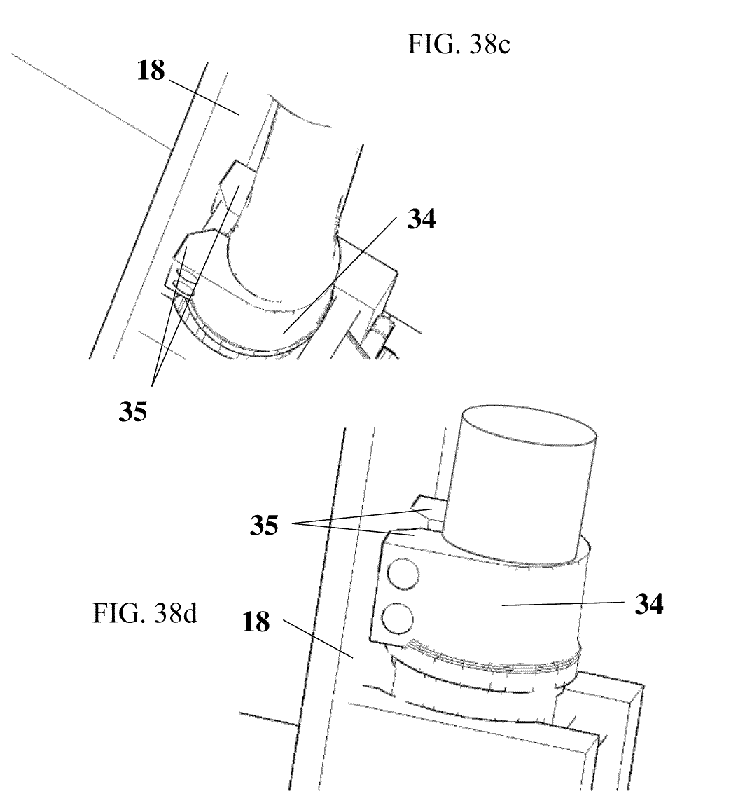

In accordance with the above embodiments, the present inventive system also provides for a wheel lock. Many conventional scooters utilize a steering tube clamp 34 to permanently secure the steering assembly 9 to the hub 32. See FIGS. 38a and 38b. This steering tube clamp 34 is generally circular but is typically comprised of clamp extensions 35 that serve as the location for fasteners. To this end, the clamp extensions 35 generally have one or several flat faces. See FIGS. 38c and 38d. The steering tube clamp 34 rotates with the steering assembly 9 when steering the scooter.

The inventive system provides for the front vertical wall 18 of rigid frame 3 to be located proximate to the steering tube clamp 34. Front vertical wall 18 will not contact steering tube clamp 34 during most steering positions, but front vertical wall will contact clamp extensions 35 in other positions. When the user rotates steering assembly 9 into a position causing clamp extensions 35 to contact front vertical wall 18, the user will feel resistance. If the user continues to rotate steering assembly 9, the resistance will increase as the clamp extensions force front vertical wall 18 to deflect. However, further rotation will cause a face of the clamp extensions 35 to lie up and settle against a congruent face of vertical wall 18. In this stable position, the clamp extensions 35 are effectively locked against front vertical wall 18. This in turn locks the steering position of the front wheel 11. See FIGS. 38c and 38d. This can be advantageous during use of the device as an article carrier. If the user wishes to unlock the steering position, they need only apply enough rotational force to the steering assembly 9 to overcome the deflection of front vertical wall 18, before clamp extensions 35 are no longer in contact with front vertical wall 18. In an alternate embodiment, and depending on the orientation of the steering tube clamp 34 with respect to the front wheel 11, side vertical walls 21 of the rigid frame 3 may be used as the locking surface, instead of front vertical wall 18.

The above described invention has many advantages over the prior art. First, it provides for a system where various article carriers can be releasably attached to various kick scooters. To attach, the user need only line up the article carrier to the corresponding attachment points at the scooter bracket 10 and steering assembly 9, then apply sufficient force to create attachment. To remove, the user need only apply sufficient force in an opposite direction to effect a release. It is preferred that the user create or release the connection with the scooter bracket 10 first, then create or release the connection with the steering assembly 9 last.

Second, the inventive system provides for a two part scooter bracket 10 which is readily attachable, permanently or semi-permanently, to most commercially available kick scooter designs. This scooter bracket 10 is especially advantageous in that it provides a secure connection with the article carrier while avoiding interference with the steering and folding functionalities of kick scooters.

Third, the inventive system provides for a front wheel lock through selectable interference between a steering tube clamp 34 and a front vertical wall 18 of rigid frame 3. This is highly advantageous in the article carrier configuration, where loose movement of the front wheel 11 and steering assembly 9 is undesirable.

Nothing contained in this specification is intended to unnecessarily limit the quantity, placement, or characteristics of the various features of the inventive system, so long as the aforementioned functionalities of the system are achieved.

We claim:

1. A scooter and article carrier system, comprising:
an article carrier, further comprised of a walled container and a rigid frame;
a wheeled land vehicle further comprised of a steering assembly, at least one front wheel, and at least one rear wheel;
a rigid bracket attached to the wheeled land vehicle at a location proximate to the front wheel;
a first connection mechanism providing for releasable attachment between a first portion of said rigid frame and said rigid bracket; and
a second connection mechanism providing for releasable attachment between a second portion of said rigid frame and said steering assembly.

2. A scooter and article carrier system, comprising:
an article carrier, further comprised of a walled container and a rigid frame;
a wheeled land vehicle further comprised of a steering assembly, at least one front wheel, and at least one rear wheel;
a rigid bracket attached to the wheeled land vehicle at a location proximate to the front wheel;
wherein said rigid bracket is further comprised of two parts, wherein each part is located on opposite sides of said location proximate to said front wheel and are releasably fastened to one another; and
a connection mechanism providing for releasable attachment between said rigid frame and said rigid bracket.

3. A scooter and article carrier system, comprising:
an article carrier, further comprised of a walled container and a rigid frame;
a wheeled land vehicle further comprised of a steering assembly, at least one front wheel, and at least one rear wheel;
wherein said steering assembly is further comprised of a clamp which secures said steering assembly to a location proximate to said front wheel;
wherein said clamp is configured to rotate between first and second positions about a longitudinal axis of said steering assembly;
wherein at said first position, said clamp does not contact said rigid frame; and
wherein at said second position, said clamp does contact said rigid frame.
